(19) United States
(12) Patent Application Publication
(10) Pub. No.: US 2025/0280311 A1
(43) Pub. Date: Sep. 4, 2025

(54) METHODS FOR ROBUST LINK PERFORMANCE MANAGEMENT FOR XR

(71) Applicant: InterDigital Patent Holdings, Inc., Wilmington, DE (US)

(72) Inventors: Senay Negusse, Montreal (CA); Jaya Rao, Montreal (CA); Tejaswinee Lutchoomun, Montreal (CA); Ananth Kini, Conshohocken, PA (US); Ahmed Mostafa, Ottawa (CA); Benoit Pelletier, Roxboro (CA); Janet Stern-Berkowitz, Little Neck, NY (US); Haseeb Ur Rehman, Winnipeg (CA)

(73) Assignee: InterDigital Patent Holdings, Inc., Wilmington, DE (US)

(21) Appl. No.: 18/859,136

(22) PCT Filed: Apr. 25, 2023
(86) PCT No.: PCT/US2023/019816

§ 371 Date: Oct. 22, 2024

Related U.S. Application Data
(60) Provisional application No. 63/335,406, filed on Apr. 27, 2022.
(60) Provisional application No. 63/395,536, filed on Aug. 5, 2022.
(60) Provisional application No. 63/421,805, filed on Nov. 2, 2022.
(60) Provisional application No. 63/454,133, filed on Mar. 23, 2023.

(51) Int. Cl. H04W 24/08

(52) U.S. Cl. CPC H04W 24/08

(57) ABSTRACT

A WTRU may receive configuration information related to handling a beam failure from a base station. The WTRU may receive one or more PDUs of a PDU set. The WTRU may receive a reference signal over the same beam and may perform a first RSRP measurement. If the measured RSRP on the beam is below a RSRP threshold, the WTRU may increment a counter and may determine the remaining delay Dᵣ of the PDU set based on the received PDUs. If the remaining delay Dᵣ is less than a value, the WTRU may select a second max count threshold based on the remaining delay Dᵣ and the association information. The WTRU may perform a second RSRP measurement and increment the counter if the RSRP is less than the threshold value. The WTRU may send a beam failure indication to the gNB when the counter reaches the second max count threshold.

### CROSS-REFERENCE TO RELATED APPLICATIONS

This application claims the benefit of U.S. Provisional Patent Application No. 63/335,406, filed on Apr. 27, 2022, U.S. Provisional Patent Application No. 63/395,536, filed on Aug. 5, 2022, U.S. Provisional Patent Application No. 63/421,805, filed on Nov. 2, 2022, and United States Provisional Patent Application No. 63/454, 133, filed on Mar. 23, 2023, the entire contents of which are incorporated herein by reference.

### BACKGROUND

The term “extended Reality” (XR) is an umbrella term for different types of immersive experiences, including Virtual Reality (VR), Augmented Reality (AR) and Mixed Reality (MR), and the realities interpolated among them. Virtual Reality (VR) is a rendered version of a delivered visual and audio scene. The rendering is designed to mimic the visual (e.g. stereoscopic 3D) and audio sensory stimuli of the real world as naturally as possible to an observer or user as they move within the limits defined by the application. Augmented Reality (AR) is when a user is provided with additional information or artificially generated objects, or content overlaid upon their current environment. Mixed Reality (MR) is an advanced form of AR where some virtual elements are inserted into the physical scene with the intent to provide the illusion that these elements are part of the real scene. XR may include all real-and-virtual combined environments and human-machine interactions generated by computer technology and/or wearables.

The notion of immersion in the context of XR services refers to the sense of being surrounded by the virtual environment, as well as providing the feeling of being physically and spatially located in the virtual environment. The levels of virtuality may range from partial sensory inputs to fully immersive multi-sensory inputs leading to a virtual reality practically indiscernible from actual reality.

XR devices may be associated with capabilities that offer various degrees of spatial tracking. XR devices may be equipped with various sensors to enable spatial tracking, for example monocular/stereo/depth cameras, radio beacons, GPS, inertial sensors, etc. Spatial tracking may be performed at different levels, e.g. 3 Degrees of Freedom (DoF) (e.g., rotational motion along X, Y and Z axis), 6 DoF (e.g., rotational and/or translational motion along X, Y and Z axis), etc. Spatial tracking may result in an interaction to experience some form of virtual content. The user may act in and/or interact with the components within extended reality. For example, the actions and/or interactions may involve movements, gestures, eye tracking, etc. Spatial tracking is an important enabler for immersive XR experience. For example, some form of head and/or motion tracking may ensure that the simulated visual and audio components from the user perspective are updated to be consistent with user's movements. Imprecise and/or delayed spatial tracking may lead to sensation of discomfort and/or motion sickness for the user.

A wireless transmit/receive unit (WTRU) may correspond to any XR device/node, which may come in a variety of form factors. A WTRU (e.g., an XR WTRU) may include, but not limited to, the following: Head Mounted Displays (HMD), optical see-through glasses and camera see-through HMDs for AR and MR, mobile devices with positional tracking and camera, wearables, etc. In addition, several different types of XR WTRU may be envisioned based on XR device functions (e.g., as display, camera, sensors, sensor processing, wireless connectivity, XR/Media processing, power supply etc.) to be provided by one or more devices, wearables, actuators, controllers and/or accessories. One or more devices/nodes/WTRUs may be grouped into a collaborative XR group for supporting XR applications/services.

### SUMMARY

Methods, systems, and instrumentalities for robust link maintenance for XR services may be disclosed herein. For example, a WTRU may receive traffic information from application/higher layers and information on association(s) between WTRUs in a collaborative group. The WTRU may send information to a network/anchor WTRU for handling link performance management (e.g., for radio link failure (RLF)/beam failure and beam management) across the group of collaborative WTRUs. The WTRU may receive configuration information from a network associated with link/beam management. The WTRU may assist with early triggering of link failure indication to prevent link failure and/or enable fast link failure recovery procedures. The WTRU may assist with fast beam failure detection and recovery. The WTRU may coordinate fast beam switch and may provide optimal beam tracking over the collaborative set of WTRUs. The WTRU may determine scheduling instances when reference signals, used for RSRP reporting and/or beam refinement, are configured and/or scheduled. The WTRU may send information to the network indicating when it is suitable to schedule CSI-RS in DL, for RSRP reporting, based on traffic the WTRU expects to receive and current information on the quality of the channel. The WTRU may send information to the network regarding XR traffic. The WTRU may receive configuration information including parameters related to two or more measurement gap periods. The WTRU may send an indication to the network indicating the measurement period to use. The WTRU may receive configuration information related to default and/or additional beam failure recovery (BFR) procedures. The WTRU may encounter a beam failure instance (BFI) and may determine a remaining delay of a PDU set. The WTRU may select a configuration to use for indicating the beam failure to the gNB.

An anchor WTRU may assist in preventing link failure in a collaborative WTRU group. The anchor WTRU, in the collaborative group of WTRUs, may determine/predict link failure instances (e.g., RLF and/or beam failure) and may assist the network in preventing link failure by providing traffic information dynamically and sending link failure indications early. The anchor WTRU may receive higher/application layer information regarding the XR experience, for example association information across the collaborative WTRUs, a WTRU-related quality of service (QoS) requirement (e.g., QoS requirements corresponding to each WTRU in the collaborative group), and/or a joint QoS requirement for the collaborative group. The anchor WTRU may receive a configuration (e.g., in RRC) comprising one or more threshold values related to the per-WTRU or joint QoS requirement (e.g., PDB) and the duration of a link failure (e.g., RLF and/or beam failure) instance. The anchor WTRU may predict an upcoming link failure and its duration on one or more Uu links corresponding to one or a subset of WTRUs in the collaborative group. If the predicted duration of the link failure instance is greater than or equal to a predetermined fraction of the PDB, the anchor WTRU may send an early link failure indication, if the predicted link failure corresponds to a single WTRU, or a joint link failure indication, if the link failure corresponds to multiple WTRUs, and the network may respond by performing one or more actions (e.g., increase transmitting power or schedule on a different RB) towards preventing the link failure. If the predicted duration of the link failure instance is less than the predetermined fraction of the PDB, the anchor WTRU may assume the link failure can recover before QoS degradation can occur and may perform no action.

Fast beam failure detection and recovery may be supported from the perspective of a collaborative WTRU. The collaborative WTRU may perform fast beam recovery based on traffic information (e.g., PDB) and time thresholds for deciding whether to use an anchor WTRU for selecting alternative beam or using a default beam failure recovery procedure. The WTRU may receive data traffic information from higher/application layer on data-type dependent packet delay budget (PDB). The WTRU may receive configuration information from an anchor WTRU (e.g., via SL), which may include an anchor-assisted time threshold for sending a beam failure indication to the anchor WTRU. The WTRU may receive configuration information from the network (e.g., in RRC), which may include a default time threshold for sending a beam failure indication to the network and a beam assignment (e.g., beam ID). The WTRU may detect a beam failure instance (e.g., RSRP measurement below threshold) on its assigned beam. The WTRU may determine whether to request assistance from the anchor WTRU or use a default procedure for beam failure recovery based on traffic information (e.g. PDB), the anchor-assisted time threshold and/or the default time threshold. If the PDB is less than the anchor-assisted time threshold, the WTRU may initiate a legacy beam failure recovery procedure. If the PDB is greater than or equal to the anchor-assisted time threshold, the WTRU may send assistance information (e.g., relative position/orientation, and current beam assignment) and request the anchor WTRU to assist with selecting an alternative beam, and receive an indication to start using an alternative beam. If the measured beam quality in the alternative beam is insufficient (e.g., RSRP measurement is below a threshold), the WTRU may initiate a default beam failure recovery procedure.

Coordinated beam maintenance from the perspective of the anchor WTRU may be supported. The anchor WTRU may determine the optimal beam for a (e.g., each) member WTRU to switch to based on assistance information from an application, the member WTRU, and the network. The anchor WTRU may receive application configuration information, which may include a data arrival rate for a (e.g., each) collaborative WTRU and/or initial special information (e.g., relative location, orientation) and the range of possible spatial changes for a (e.g., each) collaborative WTRU. The anchor WTRU may receive configuration information from a network, which may include an initial beam assigned to a (e.g., each) WTRU in the collaborative group, beam orientation information (e.g., direction, width) for one or more (e.g., all) candidate beams available for a (e.g., each) WTRU in the collaborative group, and/or beam association information indicating mapping between beam ID(s) and beam orientation information (e.g., direction, width). The anchor WTRU may calculate a beam validity interval for a (e.g., each) collaborative WTRU based on the network configuration information and application information. The WTRU may receive application data via a corresponding initial beam. The WTRU may determine the expected change in spatial information (e.g., new location, new orientation) for collaborative WTRUs based on application data and/or application configuration information. The WTRU may determine the beam switch rate for a collaborative WTRU based on the expected change in spatial information received from a member WTRU and the network configuration information. If the beam switch rate of a member WTRU is greater than the beam validity interval, the WTRU may determine the optimal beam for the member WTRU based on expected spatial information of the member WTRU and beam association information, send an indication to network on optimal beams determined for collaborative WTRUs, and/or send an indication to the collaborative WTRU on the optimal beams to use.

Dynamic adaptation of a max count number of BFIs for sending a beam failure indication to a gNB may be supported. A WTRU may receive, from a base station, configuration information related to handling a beam failure, which may include one or more of the following: one or more max count values (e.g., a default value C_{max_1} and a second value C_{max_2}) related to the maximum number of BFIs to count, BFI_count, before indicating beam failure to the gNB; a beam failure detection duration T_{BFI}; a delay threshold value D_{T} related to the remaining delay of the PDU set; an association between D_{T} and the max count value(s) (e.g., a mapping relation); and/or an RSRP threshold. The WTRU may receive, over a beam, one or more PDUs of a PDU set. The WTRU may receive a reference signal (e.g., CSI-RS) over the same beam (e.g., periodically) and may perform a first RSRP measurement. If the measured RSRP on the beam is below the RSRP threshold, the WTRU may increment BFI_count (e.g., Cₙ) by one (e.g., Cₙ₊₁), and may determine the remaining delay Dᵣ of the PDU set based on the received PDUs. For example, Cₙ may be a variable that correlates to a current value of BFI_count. If the remaining delay Dᵣ is less than a value (e.g., (C_{max_1}−1)*T_{BFI}, which may be referred to as a compare value), the WTRU may select a second max count threshold (e.g., C_{max_2}, which is less than C_{max_1}) based on the remaining delay Dᵣ and the association information. The WTRU may perform a second RSRP measurement (e.g., on CSI-RS) and may increment the BFI_count value if the RSRP is less than the threshold value. The WTRU may send a beam failure indication to the gNB when BFI_count reaches the second max count threshold (e.g., C_{max_2}).

### BRIEF DESCRIPTION OF THE FIGURES

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a group of collaborative XR devices supporting the same XR application.

FIG. 3 illustrates an example beam pattern/grid mapping.

FIG. 4 illustrates a representation of a (initial) Tx/Rx beam pattern around collaborative WTRUs.

FIG. 5 illustrates examples of a collaborative group of WTRUs receiving CSI-RS.

FIG. 6 illustrates RRM related measurement periodicity configurations.

FIG. 7 illustrates an example of adaptive setting of a maximum count value of BFIs for sending a beam failure recovery request to a gNB.

### EXAMPLE NETWORKS FOR IMPLEMENTATION OF THE INVENTION

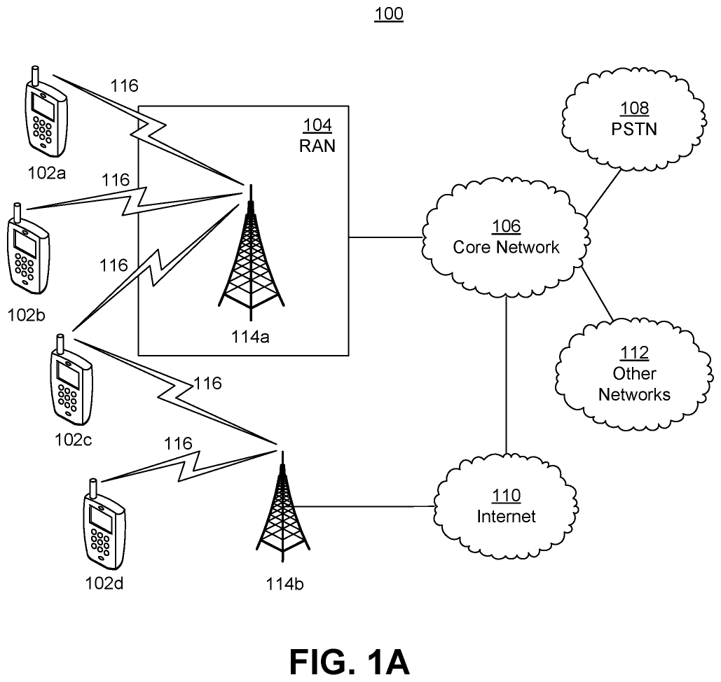

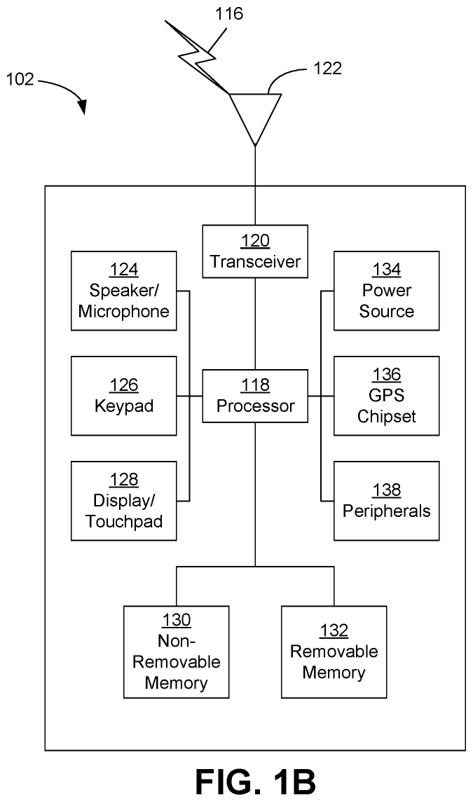

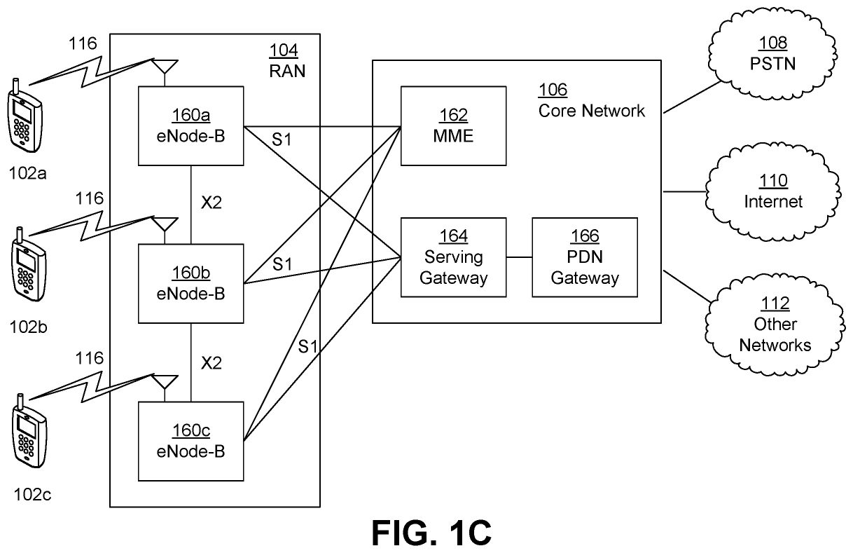

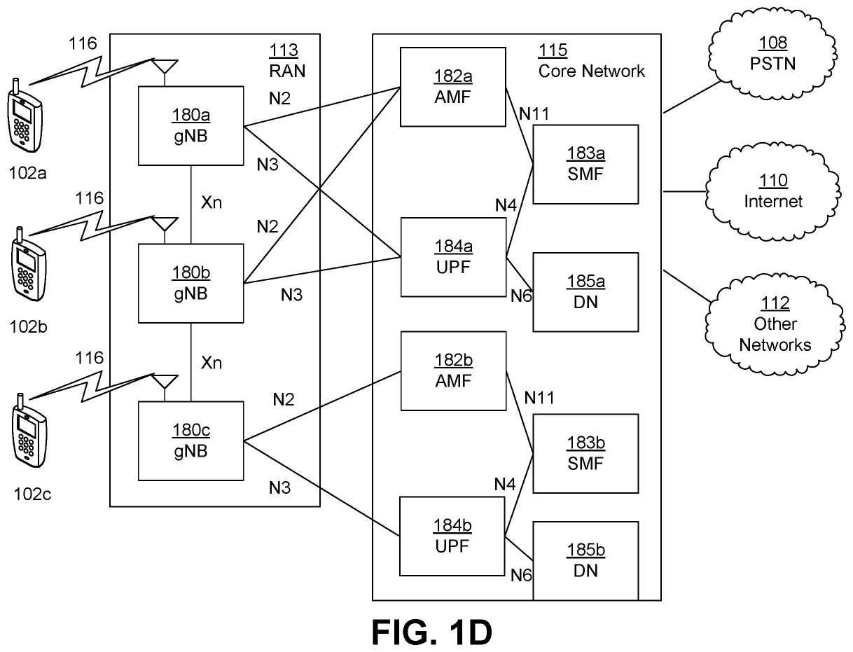

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHZ channel may be formed by combining 8 contiguous 20 MHz channels, or by combining two non-contiguous 80 MHZ channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHZ. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Link performance management may be performed. The time-varying nature of a radio propagation environment as well as imperfections in physical hardware may introduce fading and severe impairments to signals arriving at a receiver. To maintain acceptable link performance to provide a guaranteed QoS and capacity, various physical layer techniques, such as multiple antenna deployment with beamforming capabilities, etc., may be employed. Instantaneous link performance fluctuations may still occur because of poor channel conditions, WTRU mobility, etc., which may cause a significant drop in received signal power conditions resulting in poor QoS provision or even service interruption. L1/L2 configurations may be provided for performance management, enabling the link with capabilities to restore nominal operations in the event of performance drop or loss of connection.

Radio link failure and RRC reestablishment may occur. In RRC_CONNECTED, the WTRU may perform Radio Link Monitoring (RLM) in an active BWP based on reference signals (e.g., SSB/CSI-RS) and signal quality thresholds configured by the network. SSB-based RLM is based on the SSB associated with an initial DL BWP and may (e.g., only) be configured for the initial DL BWP and for DL BWPs containing the SSB associated with the initial DL BWP. For other DL BWPs, RLM may (e.g., only) be performed based on CSI-RS.

A WTRU may declare radio link failure (RLF) when one or more of the following criteria are met: expiry of a timer started after an indication of radio problems from the physical layer (e.g., if radio problems are recovered before the timer is expired, the WTRU may stop the timer); a random access procedure failure; and/or RLC failure.

After RLF is declared, the WTRU may stay in RRC_CONNECTED, select a suitable cell and initiate RRC re-establishment, and/or enter RRC_IDLE (e.g., if a suitable cell was not found within a certain amount of time after RLF was declared).

Beam management may be performed. For example, beam management may be defined as a set of L1/L2 procedures to acquire and maintain a set of transmission reception point(s) (TRxP(s) and/or WTRU beams that may be used for DL and UL transmission/reception, which may include one or more of the following aspects: beam determination (e.g., for TRxP(s) or the WTRU to select its own Tx/Rx beam(s)), beam measurement (e.g., for TRxP(s) or the WTRU to measure characteristics of received beamformed signals), beam reporting (e.g., for the WTRU to report information of beamformed signal(s) based on beam measurement), and/or beam sweeping (e.g., an operation of covering a spatial area, with beams transmitted and/or received during a time interval in a predetermined way).

Tx/Rx beam correspondence at TRxP and WTRU may be defined according to the following. Tx/Rx beam correspondence at TRxP may hold if one or more of the following conditions is satisfied: the TRxP is able to determine a TRxP Rx beam for the uplink reception based on the WTRU's downlink measurement on the TRxP's one or more Tx beams, and/or the TRxP is able to determine a TRxP Tx beam for the downlink transmission based on the TRxP's uplink measurement on the TRxP's one or more Rx beams.

Tx/Rx beam correspondence at the WTRU may hold if one or more of the following conditions is satisfied: the WTRU is able to determine a WTRU Tx beam for the uplink transmission based on the WTRU's downlink measurement on the WTRU's one or more Rx beams; the WTRU is able to determine a WTRU Rx beam for the downlink reception based on the TRxP's indication based on uplink measurement on the WTRU's one or more Tx beams; and/or capability indication of WTRU beam correspondence related information to TRxP is supported.

DL L1/L2 beam management procedures may be supported within one or more TRxPs. A first procedure (e.g., P-1) may be used to enable WTRU measurement on different TRxP Tx beams to support selection of TRxP Tx beams/WTRU Rx beam(s). For beamforming at TRxP, P-1 may include an intra/inter-TRxP Tx beam sweep from a set of different beams. For beamforming at WTRU, it may include a WTRU Rx beam sweep from a set of different beams. A second procedure (e.g., P-2) may be used to enable WTRU measurement on different TRxP Tx beams to possibly change inter/intra-TRxP Tx beam(s), for example from a smaller set of beams for beam refinement than in P-1. P-2 may be a special case of P-1. A third procedure (e.g., P-3) may be used to enable WTRU measurement on the same TRxP Tx beam to change WTRU Rx beam if the WTRU uses beamforming.

Network-triggered aperiodic beam reporting may be supported under P-1, P-2, and P-3 related operations.

WTRU measurement based on RS for beam management (e.g., at least CSI-RS) may be composed of K beams, where K may be equal to a total number of configured beams. The WTRU may report measurement results of N selected Tx beams, where N may or may not be a fixed number. A procedure based on RS for mobility purpose may not be precluded. Reporting information may include measurement quantities for N beam(s) and information indicating N DL Tx beam(s), if N<K. Specifically, when a WTRU is configured with K′>1 non-zero power (NZP) CSI-RS resources, the WTRU may report N′CRIs (CSI-RS Resource Indicator). For example, K′ may refer to a number of CSI-RS resources while K may refer to a number of configured beams. N′ may refer to a number of CSI-RS resource indicators to report, and N may refer to a number of beams for which the WTRU will report measurement.

The WTRU may be configured with one or more of the following higher-layer parameters for beam management: N>1 reporting settings and M>1 resource settings; a reporting setting; and/or a resource setting.

The WTRU may be configured with N>1 reporting settings and M>1 resource settings. The links between reporting settings and resource settings may be configured in the agreed CSI measurement setting. CSI-RS based procedure(s) (e.g., P-1 and/or P-2) may be supported with resource and reporting settings. A procedure (e.g., P-3) may be supported with or without reporting setting.

The WTRU may be configured with a reporting setting. The reporting setting may include one or more of information indicating selected beam(s), L1 measurement reporting, time-domain behavior (e.g. aperiodic, periodic, semi-persistent), and/or frequency-granularity (e.g., if multiple frequency granularities are supported).

The WTRU may be configured with a resource setting. The resource setting may include one or more of time-domain behavior (e.g., aperiodic, periodic, semi-persistent), an RS type (e.g., at least NZP CSI-RS), and/or one or more CSI-RS resources sets, with a (e.g., each) CSI-RS resource set having K≥1 CSI-RS resources. Some parameters of K CSI-RS resources may be the same (e.g. port number, time-domain behavior, density and periodicity if any).

One or more alternatives to beam reporting may be supported. In a first alternative, the WTRU may report information about TRxP Tx Beam(s) that can be received using selected WTRU Rx beam set(s), where a Rx beam set may refer to a set of WTRU Rx beams that are used for receiving a DL signal. WTRU implementation issues on how to construct the Rx beam set may be disclosed. An (e.g., each) Rx beam in a WTRU Rx beam set may correspond to a selected Rx beam in a (e.g., each) panel. For WTRUs with more than one WTRU Rx beam set, the WTRU may report TRxP Tx Beam(s) and an identifier of the associated WTRU Rx beam set per reported TX beam(s). Different TRxP Tx beams reported for the same Rx beam set may be received simultaneously at the WTRU. Different TRxP TX beams reported for different WTRU Rx beam sets may not be possible to be received simultaneously at the WTRU.

In a second alternative, the WTRU may report information about TRxP Tx Beam(s) per WTRU antenna group basis, where a WTRU antenna group may refer to a receive WTRU antenna panel or subarray. For WTRUs with more than one WTRU antenna group, the WTRU may report TRxP Tx Beam(s) and an identifier of the associated WTRU antenna group per reported TX beam. Different TX beams reported for different antenna groups may be received simultaneously at the WTRU. Different TX beams reported for the same WTRU antenna group may not be possible to be received simultaneously at the WTRU.

Beam failure detection and recovery may be performed. For beam failure detection, the gNB may configures the WTRU with beam failure detection reference signals (e.g., SSB or CSI-RS) and the WTRU may declare beam failure when the number of beam failure instance indications from the physical layer reaches a configured threshold before a configured timer expires.

SSB-based beam failure detection may be based on the SSB associated with the initial DL BWP and may (e.g., only) be configured for the initial DL BWPs and/or for DL BWPs containing the SSB associated with the initial DL BWP. For other DL BWPs, beam failure detection may (e.g., only) be performed based on CSI-RS.

The MAC entity may be configured by RRC per serving cell with a beam failure recovery procedure, which may be used for indicating to the serving gNB of a new SSB or CSI-RS when beam failure is detected on the serving SSB(s)/CSI-RS(s). Beam failure may be detected by counting beam failure instance indications from the lower layers to the MAC entity. If beamFailureRecoveryConfig is reconfigured by upper layers during an ongoing Random Access procedure for beam failure recovery for SpCell, the MAC entity may stop the ongoing Random Access procedure and initiate a Random Access procedure using the new configuration.

An RRC may configure one or more of the following parameters in the BeamFailureRecoveryConfig, BeamFailureRecoverySCellConfig, and the RadioLinkMonitoringConfig for the Beam Failure Detection and Recovery procedure: beamFailureInstanceMaxCount (e.g., for the beam failure detection); beamFailureDetectionTimer (e.g., for the beam failure detection); beamFailureRecoveryTimer (e.g., for the beam failure recovery procedure); rsrp-ThresholdSSB (e.g., an RSRP threshold for the SpCell beam failure recovery); rsrp-ThresholdBFR (e.g., an RSRP threshold for the SCell beam failure recovery); powerRampingStep (e.g., for the SpCell beam failure recovery); powerRampingStepHighPriority (e.g., for the SpCell beam failure recovery); preambleReceivedTargetPower (e.g., for the SpCell beam failure recovery); preambleTransMax (e.g., for the SpCell beam failure recovery); scalingFactorB (e.g., for the SpCell beam failure recovery); ssb-perRACH-Occasion (e.g., for the SpCell beam failure recovery using contention-free Random Access Resources); ra-ResponseWindow (e.g., the time window to monitor response(s) for the SpCell beam failure recovery using contention-free Random Access Resources); prach-ConfigurationIndex (e.g., for the SpCell beam failure recovery using contention-free Random Access Resources); ra-ssb-OccasionMaskIndex (e.g., for the SpCell beam failure recovery using contention-free Random Access Resources); ra-OccasionList (e.g., for the SpCell beam failure recovery using contention-free Random Access Resources); candidateBeamRSList (e.g., a list of candidate beams for SpCell beam failure recovery); and/or candidateBeamRSSCellList (e.g., a list of candidate beams for SCell beam failure recovery).

A WTRU variable (e.g., BFI_COUNTER), which may be initially set to 0, may be used for counting beam failure instances and for declaring beam failure if it reaches a threshold value (e.g., beamFailureInstanceMaxCount, which may also be referred to as Cₘₐₓ and/or “max count”).

After beam failure is detected, the WTRU may trigger beam failure recovery by initiating a random access procedure on the PCell and/or select a suitable beam to perform beam failure recovery (e.g., if the gNB has provided dedicated Random Access resources for certain beams, those may be prioritized by the WTRU).

Upon completion of the random access procedure, beam failure recovery may be considered complete.

Traffic models for XR applications/use cases may be provided. One or more service/traffic flows for different XR applications/use cases may be disclosed herein.

One or more virtual reality 1 (VR1) applications/use cases may be used. VR1 applications (e.g., streaming of immersive 6 degrees of freedom (6DoF)) may be modeled using service flows applicable for viewport dependent streaming architecture. Similar to adaptive streaming (e.g., DASH), viewport dependent streaming allows for dynamically updating the quality of media/video based on the available bitrate in the network and wireless interface. As per the service/traffic flow, the tracking and pose information (e.g., small packet size:<100 B) of the XR device's viewport is sent periodically with a relatively low data rate (e.g., 0.5-2 Mbps, 60 to 500 Hz) in uplink (UL) to the XR server. In response, the XR server sends in downlink (DL) with high data rate (e.g., 6-18 MBps for 4k omnidirectional and FoV area streaming) and quasi-periodically (e.g., 40/60/120 fps) the viewport optimized media adaptively (e.g., H.264/265 video), which is then rendered in the XR device display.

The traffic characteristics of VR1 may be the following. UL traffic may include pose/viewport information (e.g., including information on 6DoF), and may have a small packet size (e.g., constant size<100 B), a low data rate (e.g., 0.5-2 Mbps), and may be single flow. UL traffic may be periodic (e.g., with a periodicity range of 60 to 500 Hz). DL traffic may include media/video containing a viewport optimized scene (e.g., high quality) and/or media video for non-viewport scenes (e.g., lower quality), and may have a large packet size (e.g., variable size with Gaussian distribution or fixed size of 1500 B), a high data rate (e.g., 6-18 Mbps) and end-to-end (E2E) latency (e.g., 50 ms), and may be multi-flow (e.g., may include video flows with different bit-rates, 3D media, and/or metadata). The DL traffic may be quasi-periodic (e.g., periodicity as a function of frame rate of 40/60/120 fps).

Virtual reality 2 (VR2) applications may be used. VR2 applications (e.g., immersive game spectator mode) may be modeled using service flows which are applicable to the split rendering architecture. The XR server may perform pre-rendering and encoding of the 2D media/video frame based on the pose information sent by the XR device periodically at a low data rate (e.g., 0.5-2 Mbps, 60-500 Hz). The rendering is mainly performed in the XR-server and sent in DL at high data rate and low latency (e.g., 30-45 Mbps, 10-20 ms). The XR device decompresses the received media/video and performs asynchronous time-warping (ATW) for correcting the viewport based on the latest pose information. While RTT latency for transmission of pose information in UL and reception of pre-rendered media in DL may span up to 50 ms, ATW enables satisfying the motion-to-photon latency requirement (<20 ms) based on in-device processing.

The traffic characteristics of VR2 may be the following. UL traffic may include pose/viewport information and may have a small packet size (e.g., constant size<100 B), a low data rate (e.g., 0.5-2 Mbps), and may be single flow. UL traffic may be periodic (e.g., with a periodicity range of 60 to 500 Hz). DL traffic may include 3D scenes in frame buffers, and may have a large packet size (e.g., variable size with Gaussian distribution or fixed size of 1500 B or higher), a high data rate (e.g., 30-45 Mbps), a latency round-trip time of 30 ms or 50 ms, and may be multi-flow (e.g., may include 3D video/media and/or metadata). The DL traffic may be quasi-periodic (e.g., periodicity as a function of frame rate of 60/90 fps).

Augmented reality 1 (AR1) applications may be used. AR1 applications (e.g., real-time communication with shop assistant) may be characterized using service flows applicable to distributed computing architecture. As per the service/traffic flow, the XR device sends the pose information (e.g., 0.5-2 Mbps, 60-500 Hz)) and/or video (e.g., 10 Mbps, 10 Hz frame update rate) in UL to the XR server. The received information is used by the XR server to generate the scene, which is then converted a 2D (video) or 3D media (3D objects) format along with metadata (e.g., scene description). The compressed media and metadata (e.g., characterized by Pareto distribution) are delivered quasi-periodically in DL at a relatively high data rate (e.g., 30-45 Mbps, 40/60/120 fps). The XR device then generates the AR scene locally, by overlaying 3D objects on 2D video, and renders the scene in the device display.

The traffic characteristics of AR1 may be the following. UL traffic may include pose information and/or 2D video stream information. Pose information may have a small packet size (e.g., constant size<100B), a low data rate (e.g., 0.5-2 Mbps), and may be periodic at 60 to 500 Hz. Video information may have a relatively large packet size, a data rate of 10 Mbps, may be periodic with an update periodicity of 10 Hz, and may be multi-flow video. DL traffic may include 2D/3D pre-rendered media and XR metadata, and may have a large packet size (e.g., Pareto distribution) and a high data rate (e.g., 30-45 Mbps), and may be multi-flow (e.g., may include 2D/3D media and/or metadata). The DL traffic may be quasi-periodic (e.g., periodicity as a function of frame rate of 60/90 fps).

Augmented reality 2 (AR2) applications may be used. AR2 applications (e.g., XR meeting, AR animated avatar calls) may use service/traffic flows applicable for XR conversational architecture where two or more XR clients/devices may perform peer-to-peer communications with intermediary media processing in the network. The different types of media that may be supported for AR2 applications, based on the type of user representation, may include 2D+/RGBD (e.g., 2.7 Mbps), 3D mesh (e.g., 30 Mbps) and/or 3D Video point cloud coding (VPCC)/Geometry-based point cloud compression (GPCC) (e.g., 5-50 Mbps). An XR client in the device may initiate a call setup procedure, based on which a session control function triggers network-based media processing. The session control function also forwards the call setup to the second XR client/device, followed by real-time media processing and streaming with low latency (e.g., E2E<100 ms) to both clients. During an XR call, the 2D/3D media, and possibly the user pose information, is transmitted quasi-periodically in UL and DL between the XR clients/devices.

The traffic characteristics of AR2 may be the following. UL traffic may include 2D/3D media, and a pose and/or video of a user. The UL traffic may have a relatively large packet size, a data rate of 2.7-50 Mbps, a packet delay budget (PDB)<150 ms, and may be multi-flow (2D/3D media). UL traffic may be quasi-perioidic (e.g., 60 to 500 Hz). DL traffic may include 2D/3D media and a pose and/or video of a user. DL traffic may have a large packet size (e.g., truncated Gaussian distribution), a data rate of 2.7-50 Mbps, and an E2E PDB of <100 ms, and may be multi-flow (e.g., may include 2D/3D media). The DL traffic may be quasi-periodic (e.g., 60 to 500 Hz).

XR Conferencing applications may be used. XR Conferencing applications may provide an immersive conferencing experience between geographically remote users by representing the users in a 3D volumetric representation (e.g., point clouds or meshes). One or more cameras (e.g., with depth perception capability) may be placed at a (e.g., each) user's location to allow interactions (e.g., view, hear, rotate, zoom-in, resize, etc.) with a full 3D volumetric representation of one another on their respective devices (e.g., headsets/glasses). XR Conferencing applications may support simultaneous UL and DL media traffic, with media consisting of audio, video and/or 3D objects. The media formats that may be applied to capture the user in 3D volumetric format may include 2D+/RGBD (>2.7 Mbps for 1 camera, >5.4 Mbps for 2 cameras), 3D Mesh (˜30 Mbps) and/or 3D VPCC/GPCC (5-50 Mbps). The media processor may be located centrally or distributed on the edge. Additionally, the service/traffic flow between the XR clients/users via the in-network media processor may be similar to the AR2 and XR conversational use cases. Joining an XR conference session may result in a download peak at the beginning for downloading the virtual environment and associated media objects within the XR application. Throughout the rest of the session, data rates may vary depending on number of users, upload format of the users, and refresh rates of virtual 2D/3D objects/environment.

The traffic characteristics of XR conferencing may be the following. UL traffic may include 2D/3D media, and a pose and/or real-time video of a user. The UL traffic may have a relatively large packet size, a data rate of 2.7-50 Mbps, and may be multi-flow (2D/3D media). UL traffic may be quasi-perioidic (e.g., 60 to 500 Hz). UL traffic may have a low encoder packet error rate (PER) of <1e-3. DL traffic may include 2D/3D media, a pose and/or real-time video of a user, and 2D/3D objects/environment (e.g., which may be from a third party). DL traffic may have a large packet size, a data rate of 2.7-50 Mbps, and an E2E PDB of <100 ms, and may be multi-flow (e.g., may include 2D/3D media). The DL traffic may be quasi-periodic (e.g., 60 to 500 Hz) and may have a low encoder PER of <1e-3.

Cloud Gaming (CG) applications may be used. CG applications (e.g., 5G online gaming) may predominantly rely on an adaptive streaming architecture, where the rendered video/media in network is streamed to a thin client in the device (e.g., smartphone, tablet). In a typical service/traffic flow for CG, the XR device sends the pose information (e.g., 100 to 250 B) related to viewport periodically in UL (e.g., 0.1-1 Mbps, 60-500 Hz) to the XR server. The generated viewport-related video/media (e.g., 1500 B) is encoded/compressed (e.g., H.264/265 video) and sent quasi-periodically by the XR server in DL (e.g., 30-45 Mbps, 30/50/60/90/120 fps, PER: 10e-3). The received video/media is then rendered in the XR device upon decoding and processing. The RTT latency for supporting certain high-end CG applications (e.g., Category D: photo-realistic or natural video games) may be determined by the roundtrip interaction delay (e.g., 50 ms). For other CG applications (e.g., Categories A, B, and C defined in TR26.955), the uplink PDB is 10 ms and downlink streaming PDB may range from 50 ms to 200 ms.

The traffic characteristics of CG may be the following. UL traffic may include pose/viewport information. The UL traffic may have a relatively small packet size (e.g., 100 to 250 B), a low data rate of 0.1-1 Mbps, a PDB of 10 ms, and may be single flow. UL traffic may be perioidic (e.g., 60 to 500 Hz). DL traffic may include 2D/3D media and/or a video of the user. DL traffic may have a large packet size (e.g., max 1500 B), a high data rate of 30-45 Mbps, and a PDB of 20 ms, and may be multi-flow (e.g., may include 2D/3D media and/or video). The DL traffic may be quasi-periodic (e.g., periodicity as a function of frame rate of 30/50/60/90/120 fps) and may have a low encoder PER of <10e-3.

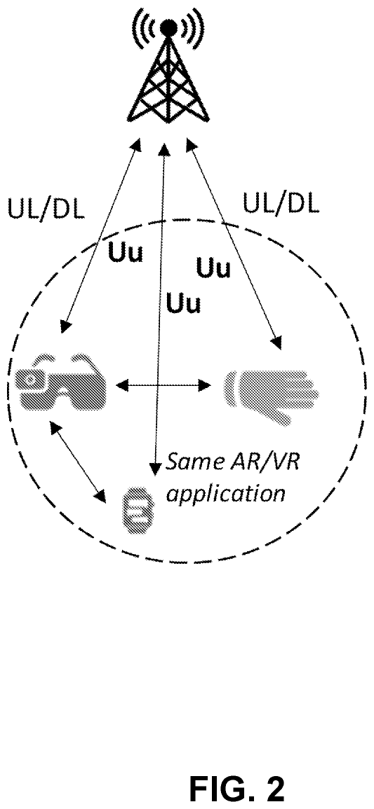

Current handling of link performance management and link maintenance in RAN for XR services may be challenging due to one or more of the following reasons. In RAN, momentary interruptions and/or downgrading in link performance may occur because of instantaneous fluctuations in the propagation channel or handover, which may result in beam switch or radio-link and/or beam failure. XR services (e.g., where information units may be carried in PDU sets) may place a strict end-to-end QoS requirement (e.g., across all PDUs in the PDU set), and the nominal link performance (e.g., with minimal interruptions and fast link/beam recovery) may need to be maintained in RAN during the transmission of the PDUs in the PDU set, with minimal interruptions or dip in performance, to fulfil the strict QoS requirement. In the event of a momentary degradation in link performance as a result of radio-link and/or beam failure or beam switch, the recovery time, defined as the duration of time spent before the nominal link performance is restored, may need to be small enough to maintain the QoS requirement. A single XR application/experience may consist of multi-flow traffic generated/received by a single WTRU (e.g., HMD: Video and pose data) or group of WTRUs (e.g., HMD, haptic gloves), for example as shown in FIG. 2. FIG. 2 illustrates a group of collaborative XR devices supporting the same XR application. Multi-flow traffic may be in a single device (e.g., HMD: video and pose data), and/or across multiple devices (e.g., HMD, haptic gloves). For a single XR application/experience with multi flow traffic across multiple devices (e.g., a collaborative group of WTRUs), the recovery time in one WTRU may affect the overall XR experience. Link/beam management may be performed without considering interdependencies and association of PDUs in a PDU set. For XR, the traffic association as well as interdependencies across PDUs in a PDU set may need to be considered when initiating and performing beam/link management procedures. Thus, adaptive beam/link management may be supported for a WTRU (e.g., or group of WTRU) running an XR application.

Because current handling of link performance management is on a per-device basis, in scenarios where the user is running an XR application on a collaborative group of devices, the traffic association as well as inter-dependencies in QoS across the collaborative group of WTRUs may not be considered when initiating (link) recovery procedures. For example, how to coordinate link management procedures across a collaborative WTRU group and leverage information such as traffic information as well as measurement gathered from each member WTRU to prevent RLC and/or how to leverage existing group information to coordinate and enable faster link failure recovery procedures if preventing RLC fails for one or a subset of WTRUs in the collaborative group may be considered.

A collaborative WTRU group may be used. As used herein, a network may include any of a base station (e.g., gNB, TRP, RAN node), core network function, and/or application function (e.g., edge server function, remote server function), etc., for example. As used herein, flows may correspond to any of: QoS flows or data flows (e.g., flow(s) of data consisting of one or more PDUs or PDU sets, which may be associated with one or more QoS requirements, e.g., latency, data rate, reliability, etc.). A PDU set (e.g., media unit, video frame) may comprise one or more PDUs. A PDU set may be associated with PDU set-level QoS requirements (e.g., data rate, latency, error rate, and/or reliability), which may be applicable for one or more (e.g., all) PDUs associated with a PDU set. The different PDUs in a PDU set may be associated with individual PDU-level QoS requirements. Such associations and inter-dependencies may be visible to the AS-layers (e.g., with associated IDs) and/or handled at the AS layers with the awareness of the association during data transmission in UL and/or reception in DL.

In an example, a WTRU may be enabled to dynamically adapt a maximum count (max count) threshold, which may be used to determine when to send an indication of beam failure (BF) to a gNB, based on association information (e.g., mapping) between the remaining delay in the PSDB and the set of maximum count thresholds for indicating BFI. The WTRU may receive configuration information related to default and additional beam failure recovery (BFR) procedure. The WTRU may encounter a beam failure instance (BFI) and may determine the remaining delay of the PDU set. The WTRU may select the configuration to use for indicating beam failure to the gNB.

As used herein, the terms “collaborative XR” or “collaborative WTRU group” may refer to, but are not limited to, supporting XR application/service, whereby one or more WTRUs may perform at least one XR-related action resulting in providing XR experiences to a user, which may include enabling the sensation whereby the user may perceive full or partial immersion in different real/virtual environments and/or the ability to interact with real and/or virtual objects, including avatars.

As used herein, the term “WTRU” may include one or more of the following: independent/stand-alone WTRUs/devices/nodes (e.g., XR devices, XR glasses, smart watches); non-stand-alone devices/nodes (e.g., devices associated with a WTRU, sensors, wearable devices, haptics gloves); devices/nodes controlled by a network (e.g., a network operator); devices/nodes that may not be directly associated with and/or connected to gNB, but may be candidate options given certain parameters (e.g., FoV metadata (e.g., size, dimension, quality, etc. of FoV), pose info); and/or stationary/static or moving/mobile devices/nodes/WTRUs. As used herein, the terms “WTRU,” “node,” and/or “device” may be used interchangeably, and may refer to any of the WTRU types described herein.

A collaborative group may consist of one or more WTRUs, where a first WTRU may be designated as an anchor WTRU and a second WTRU may be designated as a collaborative WTRU or member WTRU.

An anchor WTRU, in the context of collaborative XR, may refer to any WTRU involved in performing one or more of the following: hosting of the application function (e.g., XR application) from which a request for any XR action(s) may be received; receiving the request for an XR action from an application function located in a network (e.g., edge server, remote server); initiating a discovery procedure for determining other WTRUs/devices/nodes in proximity for performing any XR action(s) in a collaborative group; and/or establishing connectivity and/or session (e.g., XR session, PDU session, application session) by sending/receiving request for session establishment and operating as the primary anchor point for communicating with a RAN function/node (e.g., gNB), CN function and/or application function, including sending and/or receiving any of session related messages (e.g., capability transfer, assistance information transfer, configuration transfer, measurement info, XR action status info, session activation/deactivation, session release). When supporting a connection to the network, the interface between an anchor WTRU and a network (e.g., gNB) may be referred to as a primary Uu link.

The terms “collaborative WTRU” and “member WTRU” may be used interchangeably, and in the context of collaborative XR, may refer to any WTRU involved in performing one or more of the following: initiating a discovery procedure and/or receiving a request for making the WTRU discoverable (e.g., via sidelink or via network) for performing any of the XR actions described herein; sending information related to XR actions (e.g., pose info, FoV parameters including direction, width of FoV, and other FoV metadata, UL data containing the captured/mapped FoV content and/or media/video frames, assistance info, status info) directly to the network (e.g., gNB, CN function, application function) and/or indirectly to an anchor WTRU; receiving information (e.g., RRC configuration information, application configuration information), which may be used for determining any of the XR actions, possibly along with an anchor WTRU; and/or sending XR actions-related messages/reports to the anchor WTRU and/or network, including pose and/or FoV measurements and estimates over sidelink interfaces (e.g., NR sidelink, Bluetooth, WiFi Direct, etc.). When supporting a connection to the network, the interface between the collaborative WTRU and the network (e.g., gNB) may be referred to as a secondary Uu link. A collaborative WTRU may be associated with different collaborative groups and anchor WTRUs.

An XR experience may refer to the overall experience of the end user, resulting from coordinated transmission and/or reception of the correct data to the correct end device in a reliable and timely manner.

Terminology used herein related to “multi-modality” may refer to any association between multiple flows and/or multiple WTRUs, for example in a collaborative WTRU group, which may be associated with support an application/service common to one or more WTRUs.

The terminologies used herein related to “anchor WTRU” and “collaborative WTRU” are non-limiting examples. Other terminologies that may be used when referring to an anchor WTRU may include “central WTRU,” “primary WTRU,” “main WTRU,” “initiating WTRU,” etc. Other terminologies that may be used when referring to a collaborative WTRU may include “member WTRU,” “assisting WTRU,” “supporting WTRU,” “secondary WTRU,” etc.

The different attributes described herein, including collaborative group, anchor WTRU, collaborative WTRU, and/or XR actions may be associated with different identifiers/IDs (e.g., collaborative group ID, per-group anchor WTRU ID, per-group collaborative WTRU ID, XR action ID, etc.). The different identifiers/IDs associated with collaborative XR may be assigned/configured, for example, by any of the following: WTRU, network, application function, etc.

A tertiary WTRU may be a type of WTRU associated with a role in the collaborative group and functional capabilities, similar to the secondary WTRU. It may be involved in XR action for a shorter duration and/or for smaller partial task, and as a result may require a partial configuration (e.g., may take less time to complete or perform an XR action and/or with less overhead).

Methods, systems, and instrumentalities for robust link maintenance for XR services may be described herein.

A WTRU (e.g., an anchor WTRU) in a collaborative WTRU group associated with an application/experience may assist in early indication of link failure (e.g., RLF and/or beam failure) instances for one or more WTRUs and in preventing link failure (e.g., RLF and/or beam failure). Such assistance for preventing link failure may be performed as part of a link management procedure and/or a link maintenance procedure, for example. The anchor WTRU may also assist the network by providing information common to the group, enabling link failure prevention and/or coordinating faster link failure recovery procedure for the affected WTRU(s) in the collaborative group and maintaining traffic (group QoS) synchronization across WTRUs in the application.

In an example, the anchor WTRU may use information/indication received from the application/higher layer (e.g., camera FoV, pose information) and information gathered from collaborative WTRUs on channel measurement (e.g., BLER, RSRP, RSRQ, RSSI measurements) to predict an upcoming link failure (e.g., RLF and/or beam failure) and/or a duration of the link failure, in one or more links corresponding to the collaborative WTRUs. Moreover, a single link failure prediction which corresponds to a (e.g., one) WTRU in a collaborative group may also be used as a predictor of a simultaneous link failure that may occur for another WTRU in the group. Depending on the predicted duration of the link failure (e.g., RLF and/or beam failure) and the QoS associated with each traffic (e.g., PDB) corresponding to the WTRUs, the anchor WTRU may then be triggered to send an early link failure (e.g., RLF and/or beam failure) indication to the network. The network may then take one or more steps (e.g., schedule on a different RB, transmit on another carrier, duplicate packets, increase signal power, switch to a different beam, etc.) to avoid link failure and maintain the QoS requirement for the traffic towards a (e.g., each) WTRU as well as the joint QoS requirement (e.g., time difference for receiving the PDUs in different data traffic is below a threshold).

For beam failure detection, a collaborative WTRU may provide application/higher layer information (e.g., spatial orientation and/or position information) as well as beam-related (e.g., current beam it is using) information to the anchor WTRU and the network, which in return may provide the (e.g., collaborative) WTRU with assistance/configuration information on when/how it can request the anchor WTRU for assistance for fast beam failure recovery or follow the default (e.g., legacy) procedure. The anchor WTRU may use information regarding a QoS requirement (e.g., PDB) corresponding to a collaborative WTRU when providing configuration information to the collaborative WTRU on when/how it can request the anchor WTRU's assistance for fast beam failure recovery. The anchor WTRU may also use a joint QoS requirement corresponding to the collaborative group when providing configuration information which can be used when more than one collaborative WTRU requires assistance simultaneously for fast beam failure recovery.

For beam switching for optimal beam tracking, an anchor WTRU may use changes in spatial information (e.g., changes in WTRU angular orientation or relative position) and information on some aspects of the traffic characteristics (e.g., data arrival rate), received from the application/higher layer and/or information obtained from collaborative WTRUs. For example, the anchor WTRU may use the changes in spatial information (e.g., including traffic information) to determine the optimal beam it may switch to. The anchor WTRU may be configured to provide assistance to the network and the collaborative WTRUs in tracking and switching to the optimal beam as the XR experience progresses and the WTRUs move around. In coordinating and providing faster optimal beam switching capability, the anchor WTRU may ensure the joint QoS requirement for the collaborative group is maintained.

The joint QoS requirement when receiving/transmitting data/PDUs in multiple flows may be applicable for any of the QoS metrics, including but not limited to latency, data rate and reliability. In the case of a joint QoS requirement corresponding to data rate, the PDUs in one or more associated flows may be considered to fulfill the joint QoS when the PDUs are transmitted and/or received by one or more WTRUs in the collaborative group with the data rate values associated with the individual flows and at least a joint minimum or a joint maximum data rate values associated with the one or more flows associated with the application. Likewise, the joint QoS bound corresponding to latency, the PDUs in one or more associated flows may be considered to fulfil the joint QoS when the PDUs are transmitted and/or received by the WTRUs within the latency bounds (e.g. PDB) associated with the individual flows and at least within a joint minimum or a joint maximum latency bounds associated with the one or more flows belonging to the application.

The PDUs in the different traffic flows corresponding to a (e.g., each) WTRU in the collaborative group may be required to fulfil a joint QoS requirement (e.g., to avoid a drift condition where the PDUs in the different associated data flows may drift from one another). Therefore, in addition to the individual QoS requirement, the association and/or dependency of traffics across the WTRUs in the collaborative group may need to be considered when determining the condition or set of conditions that may be used by the anchor WTRU for indicating early link failure (e.g., RLF and/or beam failure), for example. However, link failure (e.g., RLF and/or beam failure) indication and recovery or prevention procedures which do not consider the association between the PDUs in the different traffics towards/from a (e.g., each) WTRU in a collaborative group may result in a timing difference in reception of the PDUs in the different data traffic which exceeds the required bound (e.g., does not fulfill the joint QoS requirement).

A WTRU may receive traffic information from application/higher layers and information on association between WTRUs in a collaborative group.

The anchor WTRU and/or more collaborative WTRUs may receive explicit and/or implicit information from the application/high layers/network indicating the traffic characteristic. The traffic information obtained by a (e.g., each) WTRU in the collaborative group of WTRUs from the application/higher layer/network for may include, for example, one or more of the following: PDB; data arrival rate; information related to the range of spatial changes (e.g., change in angular orientation of a WTRU, change in relative position of a WTRU) the user is allowed to experience or capable of making; and/or information related to the initial spatial setting (e.g., initial angular orientation, initial relative position) of each WTRU in the collaborative group.

The traffic information may be used by the anchor WTRU/network for determining traffic associations between the different WTRUs in the collaborative WTRU group and for assisting in one or more network-/anchor WTRU-related actions to enable link management. Such information may be received, periodically or aperiodically/dynamically, in RRC signaling, MAC CE, DCI, NAS-layer signalizing, SL or application layer signaling, for example.

The information received by a WTRU (e.g., an anchor WTRU) and/or network for identifying the association between WTRUs and data flows may include an identifier/ID associated with the collaborative group (e.g., a group ID associating the WTRUs to a common XR experience) and/or an identifier/ID associated with the anchor WTRU (e.g., a WTRU in a collaborative WTRU group may receive the information/ID regarding the anchor WTRU). The different identifiers/IDs associated with collaborative XR may be assigned/configured (e.g., via RRC, MAC CE, control PDU, DCI, application/NAS layer signaling, etc.) by one or more of the following: anchor WTRU, network, and/or application function.

A WTRU may send information to the network/anchor WTRU for handling link performance management (e.g., for RLF/beam failure and beam management) across a group of collaborative WTRUs.

A WTRU (e.g., an anchor WTRU and/or collaborative WTRU(s) may send information to a network and/or an anchor WTRU associated with data communications across a collaborative WTRU group, joint QoS requirement and handling of link performance management (e.g., RLF and/or beam failure, beam management) for one or a subset of WTRUs in a collaborative WTRU group. Such information may be sent, periodically or aperiodically/dynamically (e.g., based on detection of an event as described herein) as assistance information and/or a status indication. The anchor WTRU may send the information to the network via AS layer signaling (e.g., RRC signaling and/or messages, MAC CE, control PDU, or UCI) and/or Non-AS (NAS) layer signaling (e.g., PDU session related messages).

The information sent by a WTRU(s) (e.g., anchor WTRU(s) and/or collaborative WTRU(s) to the network and/or to the anchor WTRU may include the anchor WTRU's ID, IDs of the collaborative WTRUs and collaborative group ID (e.g., sent to the network), and/or traffic characteristics and/or parameters of the data/traffic associated with a (e.g., each) collaborative WTRU in the collaborative group. The WTRU may send the QoS requirements (e.g., per-WTRU), including the data rate, latency, reliability, absolute/relative priority values, etc. The WTRU may also send the joint QoS requirements associated with the collaborative group.

The anchor WTRU may send any of the information described herein to the network at the occurrence of one or more of the following events: during connectivity/session establishment and/or (re)configuration; when changing/updating a data/traffic flow in the collaborative group; when receiving higher layer/application information; when detecting a change in measurements and/or movements in one or a subset of WTRUs in the collaborative group; and/or when completing RLF recovery and reestablishing RRC connection.

The anchor WTRU may send any of the information described herein to the network during connectivity/session establishment and/or (re)configuration. For example, the anchor WTRU may send the information during RRC connection, PDU session, application session establishment and/or (re)configuration and/or when changing an RRC state in any of the WTRUs in the collaborative WTRU group.

The anchor WTRU may send any of the information described herein to the network when changing/updating a data/traffic flow in the collaborative group. For example, the anchor WTRU may send the information when adding a new WTRU to a collaborative WTRU group and/or when a WTRU is released from the collaborative group.

The anchor WTRU may send any of the information described herein to the network when receiving higher layer/application information. For example, the anchor WTRU may send the information when receiving an indication (e.g., from application function hosted in any of the WTRUs in the collaborative group or in network) indicating a change in data types supported, traffic characteristics, QoS requirements, etc.

The anchor WTRU may send any of the information described herein to the network when detecting a change in measurements and/or movements in one or a subset of WTRUs in the collaborative group. For example, the anchor WTRU may send the information when the RSRP, RSRQ, RSSI measurements of the signals, channels, radio links, carriers, etc., are above/below threshold value, and/or when pose/positioning measurements (e.g., location information, pose in 6DoF) are above/below pose threshold values.

The anchor WTRU may send any of the information described herein to the network when completing RLF recovery and reestablishing RRC connection. For example, the anchor WTRU may send the information when completing successful RRC reestablishment during RLF recovery in one or a subset of WTRUs in the collaborating group.

A WTRU may receive configuration information associated with link/beam management from a network.

A WTRU (e.g., anchor WTRU and/or collaborative WTRU) in a collaborative group may receive configuration information from the network and/or anchor WTRU which is used by the WTRU (e.g., anchor WTRU and/or collaborative WTRU) to determine when it may trigger early link failure (e.g., RLF and/or beam failure) indication or switch to an optimal beam for a WTRU or subset of WTRUs in the collaborative group of WTRUs enabling the network to maintain link performance (e.g., in beam management), prevent link failure (e.g., RLF and/or beam failure) and/or assist in fast link failure (e.g., RLF and/or beam failure) recovery procedures.

The configuration information received by the WTRU (e.g., anchor WTRU and/or collaborative WTRU) may include one or more of the following: threshold values related to individual QoS per WTRU; threshold values related to join QoS (e.g., joint PDB); threshold values related to beam validity interval; threshold values related to the instance when the WTRU can send a beam failure indication; information for associating a remaining delay for a PDU set with a max count value (e.g., a value for a number of consecutive BFIs); and/or information on the set of available beams.

The configuration information received by the WTRU (e.g., anchor WTRU and/or collaborative WTRU) may include threshold values related to individual QoS per WTRU. For example, the WTRU (e.g., anchor WTRU and/or collaborative WTRU) may receive threshold values for a (e.g., each) WTRU in the collaborative WTRU group associated with a respective PDB and the expected duration of a predicted link failure (e.g., RLF and/or beam failure) instance.

The configuration information received by the WTRU (e.g., anchor WTRU and/or collaborative WTRU) may include threshold values related to join QoS (e.g., joint PDB). For example, the WTRU (e.g., anchor WTRU and/or collaborative WTRU) may receive threshold values associated with the joint QoS requirement over the collaborative WTRU group. The joint QoS requirement on the PDUs in two or more WTRUs in the collaborative group may be related, for example, to the joint latency bound associated with the time difference between the reception time of PDUs in a (e.g., each) WTRU.

The configuration information received by the WTRU (e.g., anchor WTRU and/or collaborative WTRU) may include threshold values related to a beam validity interval. For example, the WTRU (e.g., anchor WTRU and/or collaborative WTRU) may receive threshold values associated with the rate of beam switch.

The configuration information received by the WTRU (e.g., anchor WTRU and/or collaborative WTRU) may include threshold values related to the instance when the WTRU can send a beam failure indication. For example, the WTRU (e.g., anchor UE and/or collaborative UE) may receive a threshold value related to a measured RSRP for detecting a beam failure instance (BFI). The WTRU (e.g., anchor WTRU and/or collaborative WTRU) may receive a set of Max count threshold values (e.g., a default C_{max_default} value and/or secondary Cₘₐₓ Value) related to the maximum number of BFIs to count, BFI_{count}, before indicating beam failure to gNB. In addition to max count, Cₘₐₓ, threshold values, the WTRU may also receive a beam failure detection duration timer, T_{BFI}, for beam failure detection.

The configuration information received by the WTRU (e.g., anchor WTRU and/or collaborative WTRU) may include information for associating a remaining delay for a PDU set with a max count value. For example, the WTRU (e.g., anchor WTRU and/or collaborative WTRU) may receive association information (e.g., mapping relation(s)) for selecting the max count, Cₘₐₓ, value to use based on the remaining delay, Dᵣ, to receive one or more (e.g., all) PDUs of a PDU set.

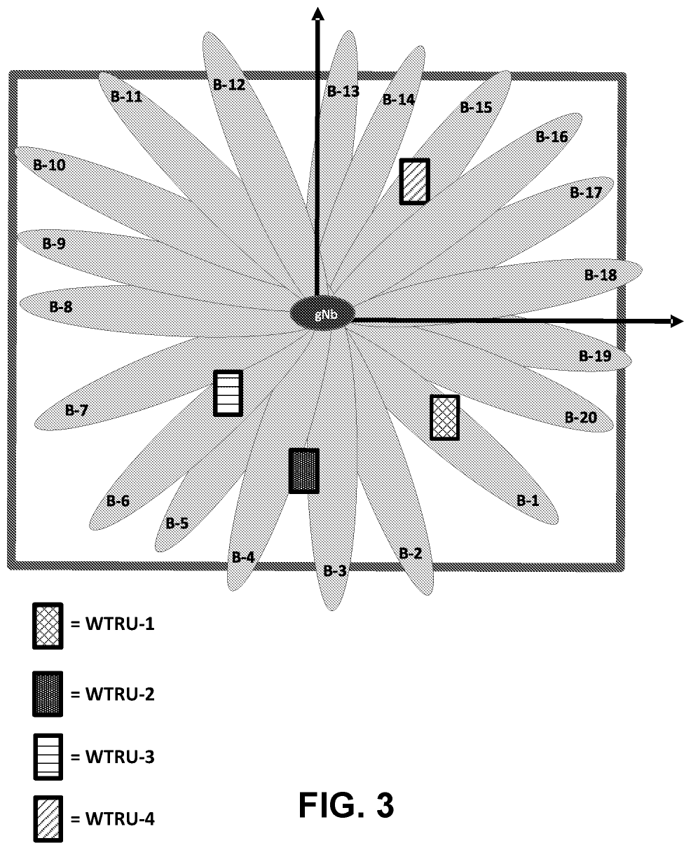

The configuration information received by the WTRU (e.g., anchor WTRU and/or collaborative WTRU) may include information on the set of available beams. For example, the network may provide the anchor WTRU with information containing the set of available beams covering the area where the collaborative group of WTRUs is present. The information provided may also contain the corresponding beam direction, orientation and/or width, allowing the anchor WTRU to have some mapping of the beam pattern/grid across the collaborative group of WTRUs as shown in FIG. 3. FIG. 3 illustrates an example beam pattern/grid mapping. The beams covering the area may be assigned respective beam IDs (e.g., B-1, B-2, . . . . B-20 shown in FIG. 3).

The WTRU may receive the configuration information via AS layer signaling (e.g., RRC signaling/messages, MAC CE or DCI) or Non-AS (NAS) layer signaling (e.g., PDU session related messages), for example.

A WTRU may assist with early triggering of a link failure indication to prevent link failure and/or enable fast link failure recovery procedures.

After receiving the configuration information, one or more WTRUs in the collaborative group may start receiving PDUs from a transmitting entity (e.g., a base station) via its corresponding Uu link. The WTRUs in the group may also perform measurements in the channel (e.g., RSRP, RSRQ, RSSI measurements) to determine the link quality, for example. The WTRUs may be configured to perform the measurements periodically, or may be triggered to perform measurements upon receiving commands from the network or anchor WTRU, for example.

The anchor WTRU may be configured to receive the reported channel measurements (e.g., RSRP, RSRQ, RSSI . . . etc.) from one or more WTRUs in the collaborative group. The anchor WTRU may use the received measurements to determine/predict an upcoming link failure (e.g., RLF and/or beam failure) for one or more Uu links corresponding to one or more WTRUs in the collaborative group. The anchor WTRU may also be able to determine/predict link failure (e.g., RLF and/or beam failure) for a WTRU based on its prediction of link failure for another WTRU in the same collaborative group which shares similar channel characteristics. A (e.g., each) link failure prediction may be accompanied by predicted link failure duration based on which anchor WTRU may trigger an early link failure indication for a WTRU or an early and joint link failure indication for a subset of WTRUs in the collaborative group.

The anchor WTRU may predict that a link failure (e.g., RLF and/or beam failure) is about to occur in one of the Uu links within the collaborative group. The anchor WTRU may obtain the prediction that a link failure (e.g., RLF and/or beam failure) is about to occur based on the gathered traffic information (e.g., FoV from camera, pose information) and/or link quality measurements (e.g., RSRP, RSRQ, RSSI measurements) performed by one or more WTRUs in the group.

If the anchor WTRU also predicts that the duration of the link failure occurrence in the collaborative WTRU will last longer than half (e.g., or some other fraction of) the PDB associated with its corresponding traffic, the anchor WTRU may send an early indication to the network that the link failure may occur at some point. The anchor WTRU may also include information indicating the WTRU to which the early RLF indication corresponds (e.g., WTRU ID).

The anchor WTRU may predict link failure occurrences in two or more Uu links in the collaborative group. The anchor WTRU may be able to predict link failure in two or more Uu links based on the gathered traffic information (e.g., FoV from camera, pose information) and/or link quality measurements (e.g., RSRP, RSRQ, RSSI measurements) from the collaborative WTRUs corresponding to a (e.g., each) link. The anchor WTRU may also be able to predict link failure in two or more Uu links based on the prediction of a link failure for a single link (e.g., two Uu links may experience similar channel conditions, therefore, a link failure (e.g., RLF and/or beam failure) predicted for one link may also serve as an indication that a link failure (e.g., RLF and/or beam failure) is about to occur in the other link as well). A (e.g., each) link failure prediction may also be accompanied by a prediction of link failure (e.g., RLF and/or beam failure) duration.

If the anchor WTRU determines that the predicted link failure durations for all but one Uu link for which it predicted link failure occurrences are shorter than half (e.g., or some other fraction of) the PDBs assigned to the corresponding links, for example, then the anchor WTRU may send an early link failure indication to the network (e.g., only) for the WTRU whose link failure duration in its Uu link is predicted to last longer than half (e.g., or some other fraction of) the PDB. The anchor WTRU may also include information indicating the WTRU to which the early link failure indication corresponds (e.g., WTRU ID).

If the anchor WTRU determines that the predicted link failure duration for two or more Uu links is going to last longer than half (e.g., or some other fraction of) the PDBs assigned to the links, for example, the anchor WTRU may send an early and joint link failure (e.g., RLF and/or beam failure) indication to the network for the group of WTRUs for which link failure is predicted. The anchor WTRU may also include information indicating a (e.g., each) WTRU to which the early link failure indication corresponds (e.g., WTRU IDs) and the joint QoS requirement for the group of WTRUs. The anchor WTRU may include the joint QoS requirement information for a group of WTRUs when sending an early indication of joint link failure for the group of WTRUs as an assistance information for the network when it undertakes steps allocating extra resources to prevent link failure (e.g., RLF and/or beam failure).

After sending the early link failure (e.g., RLF and/or beam failure) indication, the network may perform one or more actions to prevent the link failure from happening on the corresponding link/links. The action performed by the network may include, for example, one or more of the following: increasing power towards the link/links for which early RLF is indicated; switching the beam for which early beam failure is indicated; transmitting on a different band/carrier; duplicating packets; and/or employing multiple TRPs.

The network may respond to the anchor WTRU indicating that link failure (e.g., RLF and/or beam failure) for one or more WTRUs in the collaborative group is unavoidable and imminent (e.g., due to shortage of resources, unfavorable channel condition, etc.). The anchor WTRU may then indicate the WTRU or subset of WTRUs for which link failure is declared unavoidable, to initiate link recovery procedures (e.g., RRC reestablishment and/or beam reselection) without having to wait for the expiry of timer(s) (e.g., T301 timer for triggering RLF) or without having to count the maximum number of beam failure instances (e.g., beamFailureInstanceMaxCount) for triggering beam failure indication) that the WTRU is configured with before reporting link failure (e.g., RLF and/or beam failure). The anchor WTRU may also share with the network information (e.g., Cell ID, beam ID) that may be common among the group of WTRUs and which may be used to enable faster link failure (e.g., RLF and/or beam failure) recovery.

A WTRU may assist with fast beam failure detection and recovery.

For beam failure detection and recovery, after receiving configuration information from the network and/or anchor WTRU, one or more WTRUs in the collaborative group may start receiving PDUs from a transmitting entity (e.g., base station) in their corresponding Uu link and assigned Tx/Rx beam. The WTRUs in the collaborative group may also start performing periodic beam measurement (e.g., CSI-RSRP, RSRQ, RSSI measurements) to monitor beam quality.

A collaborative WTRU or subset of collaborative WTRUs in the collaborative group may detect a beam failure instance when the WTRU or subset of WTRUs measures the beam quality to be below a preconfigured threshold (e.g., RSRP threshold) value. Based on the received configuration (e.g., received from the network and/or anchor WTRU), the collaborative WTRU or subset of collaborative WTRUs which detected the beam failure instance on their assigned beam may decide to request assistance from the anchor WTRU for fast beam failure recovery, or may perform a default beam failure recovery procedure according to the network. The collaborative WTRU or subset of WTRUs may decide to employ the anchor WTRU-assisted or the network-configured beam failure recovery procedure based on one or more of the following conditions. If one or more collaborative WTRUs detect a beam failure instance and the PDB value of the traffic corresponding to the WTRU, or the joint PDB value (e.g., in case of a beam failure instance for more than one WTRU), is less than an anchor-assisted time threshold, then the WTRU or group of WTRUs may employ a network configured (e.g., default) procedure for beam failure detection and recovery. If one or more collaborative WTRUs detect a beam failure instance and the PDB value of the traffic corresponding to the WTRU, or the joint PDB value (e.g., in case of a beam failure instance for more than one WTRU), is greater than the anchor-assisted time threshold, then the WTRU or group of WTRUs may send an indication to the anchor WTRU requesting assistance on fast beam failure recovery.

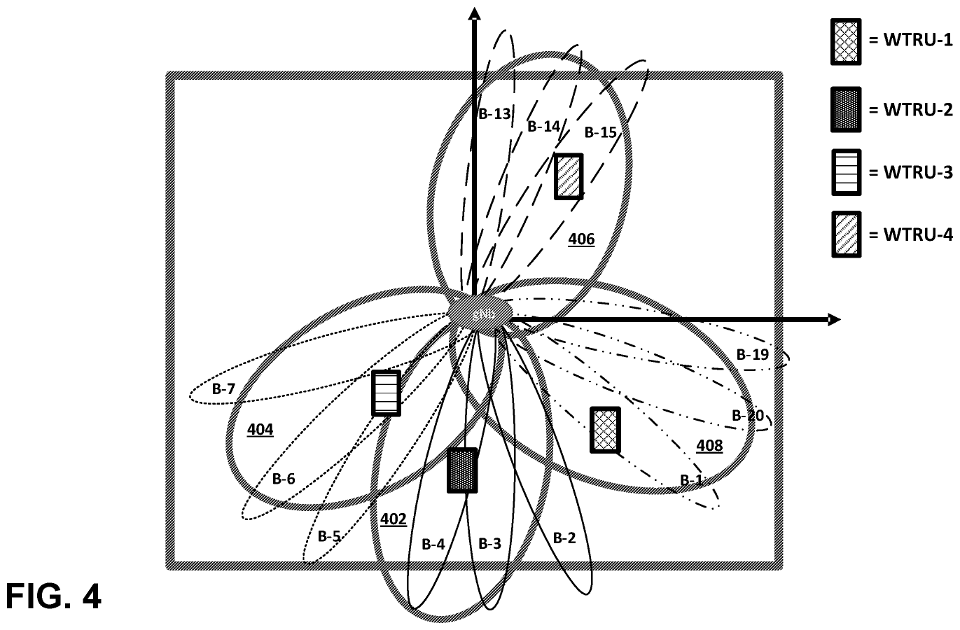

Collaborative WTRUs and the network may provide the anchor WTRU with current information regarding the Tx/Rx beam assignment (e.g., beam orientation, beam width, AoD and AoA of boresight, etc.) enabling the anchor WTRU to have a close representation of the Tx/Rx beam pattern, as shown in FIG. 4, around the collaborative WTRU group. FIG. 4 illustrates a representation of a (initial) Tx/Rx beam pattern around collaborative WTRUs. The representation shown in FIG. 4 may be derived from the beam pattern/grid map shown in FIG. 3.

A collaborative WTRU or subset of WTRUs may include application/higher layer spatial information (e.g., current relative position and/or angular orientation) and/or lower layer information (e.g., current beam assignment) when sending an indication to the anchor WTRU requesting assistance on fast beam failure recovery. The anchor WTRU may assist the collaborative WTRUs by sending an indication informing the network of the set of beams that is most suitable to switch to and assigning the set of beams to the WTRU or set of WTRUs requesting assistance for fast beam failure recovery.

An anchor WTRU may be able to determine the most suitable beam to switch to and assign to a WTRU or set of WTRUs based on the current spatial information it is provided and the representation of the Tx/Rx beam pattern (e.g., as shown in FIG. 4) which is made available to it. As shown in FIG. 4, beams may be grouped into beam patterns. For example, beams B-2, B-3, and B-4 may be grouped into beam pattern 402, beams B-5, B-6, and B-7 may be grouped into beam pattern 404, beams B-13, B-14, and B-15 may be grouped into beam pattern 406, and beams B-19, B-20, and B-1 may be grouped into beam pattern 408 For example, if a WTRU (e.g., WTRU-2 in FIG. 4), which was assigned a first beam (e.g., beam “B-3”) for communicating with a transmitting entity (e.g., base station) requests assistance from an anchor WTRU (e.g., WTRU-1 in FIG. 4) for fast beam failure recovery, the anchor WTRU, knowing the WTRU's current assigned beam (e.g., the beam on which beam failure instance is detected), and spatial information (e.g., angular orientation and/position) may be able to determine the WTRU can recover its beam if it is assigned to a different beam (e.g., the beam B-4) by the network.

The network may then switch to the beam indicated by the anchor WTRU when communicating with the collaborative WTRU or subset of WTRUs which detected the beam failure instance. The network may also indicate to the WTRUs or subset of WTRUs to start measuring the beams (e.g., RSRP, RSRQ measurements) it switched to. If the WTRU or subset of WTRUs still detects a beam failure instance based on measurements performed in the newly selected beam/beams, then the WTRU or subset of WTRUs may fall back to the default (e.g., network configured) procedure to initiate a beam failure recovery procedure. If the WTRU or subset of WTRUs does not detect a beam failure instance when measuring on the newly selected beam/beams, then the WTRU or subset of WTRUs may maintain transmission and reception on the beam/beams.

A WTRU may coordinate fast beam switch and may provide optimal beam tracking over a collaborative set of WTRUs.

In an example, after receiving configuration information and/or application related information, the anchor WTRU may determine a beam validity interval for the beams assigned to a (e.g., each) WTRU in the collaborative group set. The beam validity interval may be related to the range of spatial change (e.g., change in angular orientation, relative position) a WTRU may undergo before the beam assigned to it is no longer optimal. The WTRUs in the collaborative group may start receiving PDUs from a transmitting entity (e.g., base station) in their assigned Tx/Rx beam(s).

The anchor WTRU may use the set of PDUs received from the transmitting entity (e.g., base station, application layer) and/or the application/configuration information (e.g., range of possible spatial changes for a WTRU), to determine/predict the expected change in some aspects of the spatial information corresponding to a collaborative WTRU or subset of WTRUs. Aspects of spatial information the anchor WTRU may be able to determine/predict may include an angular orientation of a WTRU along a given axis and/or a position of the WTRU relative to the anchor WTRU and/or the transmitting entity (e.g., base station)

Based on the changes in aspects of the spatial information a collaborative WTRU or subset of WTRUs are expected to experience and/or configuration information provided by the network, the anchor WTRU may determine the beam switch rate for the collaborative WTRU or subset of WTRUs. The configuration information provided by the network to the anchor WTRU/collaborative WTRU may include the beam pattern/grid map corresponding to the collaborative group (e.g., as shown in FIG. 3) and current beam assignments towards a (e.g., each) WTRU in the collaborative group (e.g., as shown in FIG. 4).

If the rate of beam switch for a collaborative WTRU or subset of WTRUs is greater than the validity interval of the corresponding beam or subset of beams, then the anchor WTRU may determine the optimal beam or set of optimal beams that the WTRU or subset of WTRUs may switch to. The anchor WTRU may determine the new optimal beam for a WTRU or set of optimal beams for subset of WTRUs based on the expected change in spatial information and the beam pattern/grid map (e.g., as shown in FIG. 3) which may be made available to the anchor WTRU.

The network, upon receiving an indication from the anchor WTRU, may switch the beam or set of beams when communicating with the corresponding WTRU or set of WTRUs.

The WTRU may determine instances when it is suitable to schedule CSI-RS/SRS based on expected DL/UL traffic and channel conditions. The WTRU, in addition to determining the characteristics of the traffic expected in DL and/or UL, may acquire information on the quality of the propagation channel and/or received signal strength for a given duration of time into the future based on received DL and/or UL traffics and/or measurements over beamformed DMRS. Based on the information the WTRU acquires and the expected change in the channel and/or received DL/UL signal strength, the WTRU may determine whether to send an indication to the network indicating the next DL and/or UL transmission instance/occasion that is suitable for transmission of CSI-RS to the WTRU and/or for the WTRU to transmit SRS to the network, so that some measure of channel quality (e.g., RSRP) may be reported for link adaptation, beam management and/or RLM.

The WTRU may also be an anchor WTRU which determines the suitable DL/UL transmission time instant for scheduling CSI-RS/SRS transmission to a member WTRU, or set of member WTRUs, in a collaborative group of WTRUs. By scheduling transmission of CSI-RS and/or SRS (e.g., only) when necessary and according to the characteristics of the expected DL and/or UL traffic, the network may be able to save resources and improve capacity for the WTRU. Additionally, for a collaborative group of WTRUs located close to each other, where the link quality towards member WTRUs may be similar or identical, (e.g., only) the anchor WTRU may be configured with CSI-RS and/or SRS and/or to report channel quality measurement (e.g., RSRP) for itself and/or for member WTRUs, thereby saving resources and improving capacity over the group of collaborative WTRUs.

The CSI-RS and SRS resource configuration may be periodic, aperiodic, or semi persistent CSI-RS transmission. In periodic transmission, the WTRU may expect to receive/transmit CSI-RS/SRS in resource sets which may be reserved at periodic intervals. In aperiodic transmission, the WTRU may receive explicit signaling from the network (e.g., in DCI) indicating CSI-RS/SRS transmission instances. For XR services, periodic transmission of CSI-RS/SRS may incur extra overhead, which may potentially lower the capacity. The aperiodic transmission of CSI-RS/SRS after a data/control/periodic CSI-RS transmission may be good enough to satisfy the tight latency requirement. Semi-persistent CSI-RS/SRS transmission may reduce resource overhead since, even if the WTRU is configured with periodic resource sets, CSI-RS/SRS is transmitted (e.g., only) after explicit activation via MAC CE and/or may also be deactivated after some time. However, for beam management or RLM in services with faster response time, semi-persistent CSI-RS/SRS transmission may not be suitable. For XR services, solutions based on dynamic/adaptive CSI-RS/SRS configuration that provide robust link management with balanced tradeoffs between capacity and latency may be useful.

The WTRU may obtain measurements on link and/or channel quality as well as received DL and/or UL signal strength using reference signals (e.g., DMRS), which may be scheduled with PDSCH/PUSCH. The WTRU may receive CSI-RS (e.g., only) when it is expected to report to the network on expected changes in channel quality and/or DL/UL received signal strength. The WTRU (e.g., anchor WTRU) may send information associated with the application to the network as assistance information and/or status information/indication. In an example, the information associated with the application, which may be sent by the WTRU to the network, may include traffic characteristics and/or parameters for the application. The WTRU may send the QoS requirements (e.g., per-WTRU in case of collaborative group of WTRUs), including the data rate, latency, reliability, absolute/relative priority values, etc. In the case of a collaborative group of WTRUs, the WTRU may send the position (e.g., location and/or orientation) of WTRUs in the collaborative group relative to the anchor WTRUs.

The WTRU (e.g., anchor WTRU) may send the information to the network at one or more of the following points: during connectivity/session establishment and/or (re)configuration; when changing/updating a data/traffic flow in the collaborating group; when receiving higher layer/application information; and/or when detecting a change in measurements and movements in one or a subset of WTRUs in the collaborating group.

The WTRU (e.g., anchor WTRU) may send the information to the network during connectivity/session establishment and/or (re)configuration. For example, the WTRU may send the information to the network during RRC connection, PDU session, application session establishment and/or (re)configuration; when changing an RRC state in any of the WTRUs in the collaborative WTRU group; and/or when completing successful RRC reestablishment during RLF recovery in one or a subset of WTRUs in the collaborating group.

The WTRU (e.g., anchor WTRU) may send the information to the network when changing/updating a data/traffic flow in the collaborating group. For example, the WTRU may send the information to the network when a new WTRU is added to a collaborative WTRU group and/or when a WTRU is released from the collaborative group

The WTRU (e.g., anchor WTRU) may send the information to the network when it receives higher layer/application information. For example, the WTRU may send the information to the network when it receives an indication (e.g., from an application layer) indicating a change in traffic characteristics, QoS requirements, etc.

The WTRU (e.g., anchor WTRU) may send the information to the network when it detects a change in measurements and/or movements in one or a subset of WTRUs in the collaborating group. For example, the WTRU may send the information to the network when one or more of the WTRUs in the collaborating group moves a certain distance beyond a threshold where link/channel quality may no longer be identical and/or correlated.

The WTRU (e.g., anchor WTRU) may determine the instance and/or period of time when it is suitable for CSI-RS to be transmitted to it, and/or for the WTRU to send SRS to the network (e.g., in terms of the tradeoff between resource overhead, reliability and/or latency) based on configuration information sent by the network, which may consist of one or more parameters, threshold values and/or triggering conditions. The configuration information received by the WTRU may include one or more of the following: threshold values related to the measured channel quality and/or received signal strength; threshold values related to the spatial and/or angular orientation; threshold values related to the QoS; and/or information on the sets of WTRUs in a collaborative group of WTRUs which are covered by the same CSI-RS/SRS transmission.

The configuration information received by the WTRU may include threshold values related to the measured channel quality and/or received signal strength. For example, the WTRU (e.g., anchor WTRU) may receive a set of threshold values (e.g., threshold 1 and threshold 2, which may be threshold values related to the channel quality measurement or signal strength measurement such that threshold 1<threshold 2) related to the channel quality (e.g., CQI) of its Uu link and/or received signal strength in DL and/or UL (e.g., RSRP, SNR, etc.).

The configuration information received by the WTRU may include threshold values related to spatial and/or angular orientation. For example, the WTRU (e.g., anchor WTRU) may receive a threshold associated with the change in its spatial and/or angular orientation and/or the change in spatial and/or angular orientation of member WTRUs in a collaborative group of WTRUs.

The configuration information received by the WTRU may include threshold values related to the QoS. For example, the WTRU (e.g., anchor WTRU) may receive a threshold associated with the PDB and a required PER/BLER. A collaborative group of WTRUs (e.g., anchor WTRUs) may receive threshold values associated with the joint QoS (e.g., joint PDB).

The configuration information received by the WTRU may include information on the sets of WTRUs in a collaborative group of WTRUs which are covered by the same CSI-RS/SRS transmission. For example, in the case of a collaborative group of WTRUs, the WTRU (e.g., anchor WTRU) may receive the set of WTRUs that are covered by the channel quality measurement report (e.g., SNR/SINR, RSRP, CQI, etc.) that the WTRU obtains based on the CSI-RS and/or the SRS it is configured with. As an example, (e.g., only) one WTRU (e.g., anchor WTRU) may be configured with CSI-RS and/or SRS without configuring the remaining WTRUs, and/or the measurements obtained from and/or by the WTRU may be also valid to one or more (e.g., all) other WTRUs in the group. The group of collaborative WTRUs may further be grouped based on their relative proximity to each other. One or more representative WTRUs in a sub-group within the group may be configured with CSI-RS and/or SRS. In this case, the channel quality report sent by and/or obtained from the representative WTRUs may be considered to cover one or more (e.g., all) WTRUs within the sub-group.

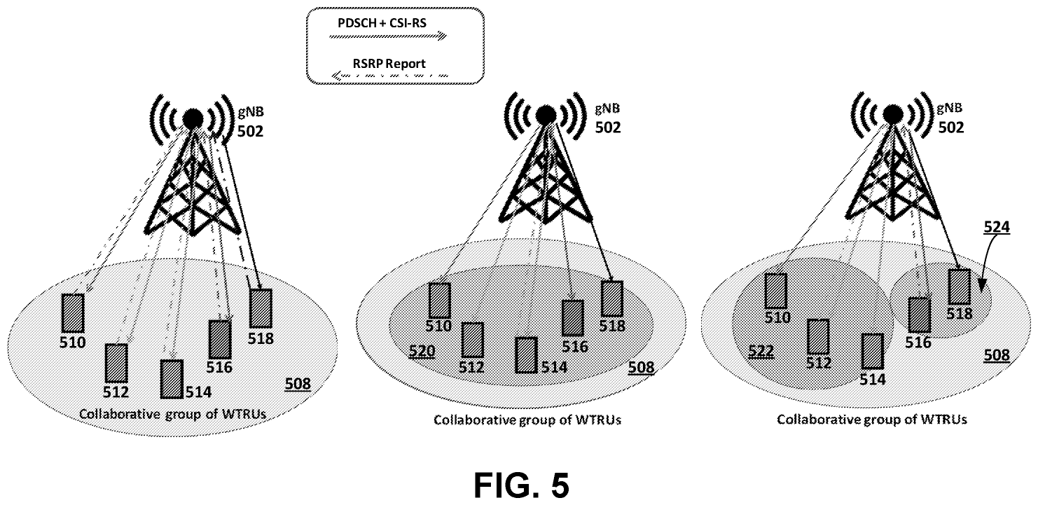

FIG. 5 illustrates examples of a collaborative group of WTRUs receiving CSI-RS. As shown in FIG. 5, one or more (e.g., all) WTRUs in the collaborative group may receive the CSI-RS (e.g., the left side of FIG. 5). Alternatively, one WTRU (e.g., anchor WTRU) may receive the CSI-RS (e.g., the center of FIG. 5), or one WTRU per sub-group may receive the CSI-RS (e.g., the right side of FIG. 5).

For example, as shown in FIG. 5, a gNB 502 may transmit CSI-RS to a collaborative group of WTRUs 508, which may include WTRUs 510, 512, 514, 516, and 518. In the left side of FIG. 5, all of the WTRUs 510, 512, 514, 516, and 518 may receive the CSI-RS and/or may transmit an RSRP report to the gNB 502. Alternatively, the WTRUs may be grouped into a sub-group 520, and one WTRU (e.g., WTRU 514) may receive the CSI-RS and/or transmit the RSRP report. Alternatively, the WTRUs may be split into two or more sub-groups, for example a first sub-group 522 and a second sub-group 524. The first sub-group 522 may include WTRUs 510, 512, and 514, and the second sub-group 524 may include WTRUs 516 and 518. One WTRU per sub-group (e.g., WTRU 512 and WTRU 516) may receive the CSI-RS and/or transmit the RSRP report to the gNB 502.

After receiving the configuration information, the WTRU may start to receive and transmit PDUs in DL and UL, possibly after obtaining the suitable/optimal transmission and reception beam and other radio link parameters. The WTRU may determine and/or predict some measure of the channel quality over the Uu link and/or the received signal strength for a given duration of time in the future based on information it acquired in the past, as well as current channel and/or DL/UL signal measurements. For of a collaborative group of WTRUs, the anchor WTRU may determine and/or predict the expected channel quality and/or received signal strength for a member WTRU based on channel measurement information provided by the member WTRU (e.g., over SL) to the anchor WTRU. The channel quality and/or DL signal strength measurement may include, for example, an expected SNR/SINR, an expected RSRP measurement, and/or an expected CQI.

After preparing and transmitting UL PDUs, the WTRU (e.g., anchor WTRU) may be able to determine and/or predict aspects of the traffic expected in DL and/or UL for a given duration of time in the future. For a collaborative group of WTRUs, the WTRU may also determine and/or predict characteristics of the DL traffic a member WTRU may be expected to receive in DL and/or transmit in UL during a period of time in the future. The characteristics and/or aspects of the DL and/or UL traffic the WTRU may be able to determine and/or predict may include, for example, an expected change in QoS (e.g., PDB/PER), an expected change in joint QoS (e.g., joint PDB), and/or an expected time of arrival of DL/UL PDUs.

In an example applicable to DL transmission, the WTRU (e.g., anchor WTRU) may determine and/or predict a change in the measured channel quality and/or received signal strength, a change in the expected QoS, and/or a change in the expected joint QoS across a collaborative group of WTRUs (e.g., PDB, required PER). If the WTRU determines and/or predicts that the change in the expected channel quality measurement (e.g., SNR/SINR, RSRP, CQI, etc.) is above a first threshold value and/or below a second threshold value of the configured thresholds related to the channel quality measurement, then the WTRU may further determine and/or predict the change in the QoS of the traffic expected in DL. If the WTRU further determines that the change in the QoS of the traffic it expects in DL and/or UL is above the configured threshold related to the QoS and/or joint QoS, the WTRU may send an indication to the network to transmit CSI-RS in the next PDSCH transmission instance. This may be done to report the expected change in the channel quality and/or received signal strength (e.g., SNR, RSRP) for the purpose of link adaptation, radio line management, beam management and/or to manage an expected radio link or beam failure.

If the WTRU determines and/or predicts that the change in the expected channel quality measurement (e.g., SNR/SINR, RSRP, CQI, etc.) is above the second threshold value (e.g., implying significant expected change in channel quality measurement), then the WTRU may send an indication to the network, regardless of the expected change in the QoS and/or joint QoS, to transmit CSI-RS in the next PDSCH transmission instance to report the expected change in the channel quality measurement and/or received signal strength (e.g., SNR, RSRP).

After the WTRU (e.g., anchor WTRU) determines that it is expected to send an indication to the network to transmit CSI-RS, it may also determine that the next transmission time instance when the network may send the CSI-RS is a long time ahead and/or may lead to a delay longer than the PDB required to maintain good quality of experience (QoE) before the WTRU receives CSI-RS and reports back measurement on the change in channel quality and/or received signal strength and the network can take appropriate actions (e.g., switch beam, increase power, etc.). In this case, instead of indicating for CSI-RS to be transmitted in the next DL transmission time instance, the WTRU may indicate to the network to transmit CSI-RS in the next DRX ON cycle, even if there is no DL traffic scheduled, for urgent reporting of channel quality measurement.

In an example applicable to UL transmission, based on the PDUs received in DL and/or PDUs transmitted in UL, the WTRU (e.g., anchor WTRU) may determine and/or predict a change in its spatial and/or angular orientation, which in turn may affect the channel/radio link/beam quality and the signal strength received in UL. Based on the magnitude of the change in spatial and/or angular orientation, the WTRU may determine when to send an indication to the network that includes a request for sending SRS, so that the network may immediately measure the change in the channel quality and/or received signal (e.g., beam) strength corresponding to the change in the spatial and/or angular orientation of the WTRU, and/or take the appropriate action (e.g., switch beams).

If the WTRU (e.g., anchor WTRU) determines and/or predicts that the change in spatial and/or angular orientation of the WTRU is above a configured threshold, then it may send a request to the network to obtain a resource grant to send SRS in the next available transmission instance.

After receiving the indication, the WTRU (e.g., anchor WTRU) may receive an acknowledgment to expect CSI-RS in the next PDSCH transmission instance or the next DRX ON cycle and/or to send SRS to the network in the next PUSCH transmission instance.

A WTRU may be configured to determine a measurement periodicity for radio resource management (RRM) related measurements. For example, the WTRU may determine the appropriate measurement periodicity for the WTRU measurement configuration for performing RRM related measurements.

A WTRU may receive configuration information from the network including two or more parameters related to periodicity values for performing RRM-related measurements. The WTRU may select the measurement periodicity (e.g., of the configured periodicities) to use for RRM-related measurements. For example, the RRM-related measurements may be measurements of one or more an SSB, a CSI-RS, etc. The WTRU may select the measurement periodicity (e.g., of the configured periodicities) to use for RRM-related measurements based on acquired information relating to one or more of the rate of change in the propagation channel and/or the traffic information. The WTRU may assist in maintaining link performance (e.g., acceptable link performance) under varying channel conditions and mobility adapting to the XR traffic requirements, for example by dynamically or semi-statically changing the measurement periodicity for RRM-related measurements.

In an example, the WTRU may perform RRM-related measurement(s) periodically on configured resource sets. For example, the WTRU may reserve or utilize one or more configured resource sets at periodic intervals. The RRM-related measurement(s) may be measurements performed for the purpose of selecting one or more cells, for supporting radio access technology (RAT) handover, for supporting BWP switching, etc. For example, the configured resource sets may include one or more of an SSB or a CSI-RS. Measurement instances which occur at short intervals (e.g., relatively short measurement periodicities) may incur more frequent interruptions in DL/UL reception/transmission of traffic for the WTRU for a given duration of time, which may lead to a reduction in throughput. Measurement instances which occur at short intervals may introduce longer latency resulting in poor QOE for the XR application. Measurement instances which occur in long intervals (e.g., relatively long periodicities) may not allow the gNB and the WTRU to adapt to changes quickly, resulting in the network not being able to update RRM configuration(s) fast enough relative to the PDB in the XR traffic. For example, the WTRU may perform measurements in order to adapt to changes in one or more of a channel condition, a WTRU location, and/or a WTRU speed. Based on changes in these channel conditions and/or measurement reports sent by the WTRU, the WTRU may be configured to use modified RRM configurations, which may include updating of one or more BWP configuration/switching, cell (e.g., RLM) configuration, or beam configuration/handover, etc. Measurement instances which occur in long intervals may lead to radio link failure. For XR services, an embodiment based on dynamic/adaptive configuration RRM related measurement periodicity may provide robust link performance, while at the same time providing a balanced tradeoffs in capacity and latency.

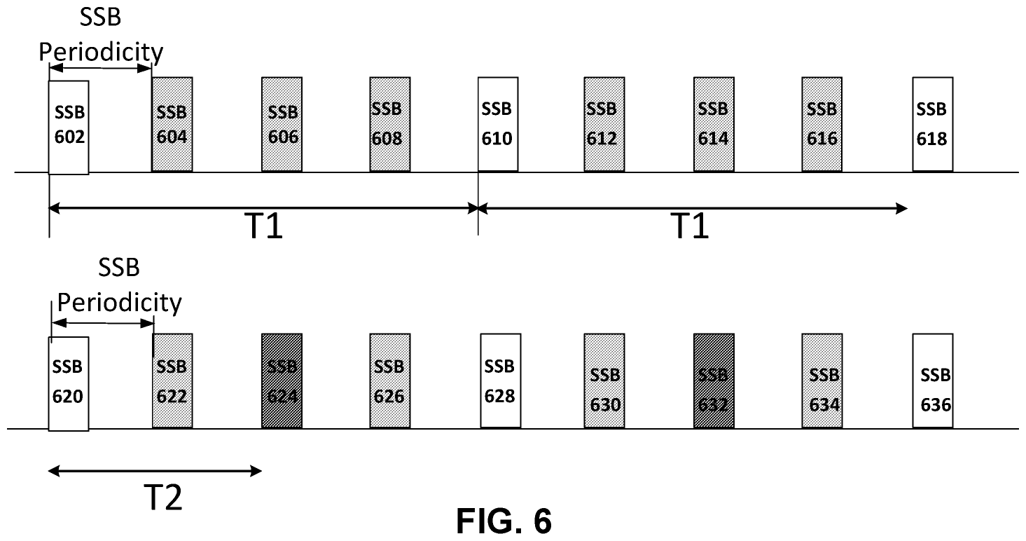

FIG. 6 illustrates RRM-related measurement periodicity configuration. As shown in FIG. 6, the WTRU may receive, from the gNB, at least one (e.g., default) configuration for RRM-related measurement periodicity, T1, and an additional configuration related to a second measurement periodicity, T2, where the first (e.g., default) measurement periodicity, T1, may be greater than the second measurement periodicity, T2 (i.e., T1>T2), as shown in FIG. 6. For example, the RRM related measurement may include an SSB, or a CSI-RS measurement. For example, as shown in FIG. 6, T1 may include SSBs 602, 604, 606, and 608, and/or SSBs 610, 612, 614, 616, and 618. T2 may include SSBs 620, 622, and/or 624.

The WTRU may start DL/UL reception/transmission and perform RRM-related measurements every period (e.g., every T1 period) with a configured measurement duration (e.g., measurement gap) during which DL/UL reception/transmission may be interrupted. The WTRU may also measure changes in the link quality and/or propagation channel, for example while receiving DL traffic using reference signals (e.g., demodulation reference signals (DMRS)). The WTRU may determine that a change in RRM-related procedures should occur (e.g., a change in periodicity) based on the observed rate of change in link and/or channel quality. For example, the observed rate of change in link and/or channel quality may include the rate of change in DMRS-based reference signal received power (RSRP). For example, the RRM-related procedures may include one or more of hand over, cell reselection, radio link monitoring, BWP switching, etc. The WTRU may receive configuration information from the gNB consisting of threshold value(s) related to the rate of change in the measured link and/or channel quality (e.g., rate of change in measured RSRP values) and/or the packet arrival rate in the XR traffic. When these threshold(s) are exceeded, the WTRU may be configured to adapt one or more RRM configuration parameters (e.g., measurement periodicity).

The WTRU may obtain measurements on link and/or channel quality as well as received DL strength (e.g., RSRP) using reference signals. For example, DMRS, which may be scheduled with physical downlink shared channel (PDSCH) transmissions, may be used for measurements. The WTRU may also determine the rate, Rₘ, at which link and/or channel quality measurements change between measurement instances. The rate, Rₘ, of change in the measured link and/or channel quality between measurement instances may indicate that one or more of the following events are expected to occur: an increase in mobility of WTRU, a blockage, and/or a link/beam failure. The WTRU may further determine that RRM-related procedures corresponding to the events (e.g., blockage, increased mobility, link/beam failure) are expected to occur. For example, the RRM related procedures may include, but are not limited to, handover, cell selection, cell reselection, BWP switching, beam selection, and/or beam reselection.

Based on the observed rate, Rₘ, at which link and/or channel quality measurements change between measurement instances, the WTRU may determine whether to switch the RRM-related (e.g., SSB, CSI-RS) measurement interval (e.g., periodicity) from a first value to a second value (e.g., T1 to T2) and send an indication to the gNB. The indication may indicate that the WTRU has changed its RRM measurement periodicity and/or adapted one or more RRM-related configuration parameters. The indication may indicate the changed periodicity/RRM configuration parameter(s) value. If the WTRU determines that the rate, Rₘ, at which link and/or channel quality measurements (e.g., measured RSRP, RSRQ, etc.) change between measurement instances is greater than the packet arrival rate for the XR traffic, the WTRU may switch the RRM-related measurement interval (e.g., periodicity) from a first value to a second value (e.g., T1 to T2), such that the WTRU may perform RRM related measurement at shorter intervals. If, however, the WTRU determines that the rate, Rₘ, at which link and/or channel quality measurements (e.g., measured RSRP, RSRQ, etc.) change between measurement instances is less than the packet arrival rate, the WTRU may maintain the RRM-related measurement interval (periodicity) at the first value (e.g., T1).

A WTRU may dynamically adapt the maximum number of BFI counts it needs to perform before declaring beam failure and/or sending a beam failure indication to the gNB. In an example, a WTRU may receive configuration information from the network consisting of two or more max count values related to the number of BFIs the WTRU has to count before declaring beam failure and sending a beam failure indication to network. During reception of PDUs from a PDU set, the WTRU may need to maintain nominal link performance and may dynamically adapt to channel conditions to fulfill the PDU set-level delay budget and maintain the dependency across PDUs in the PDU set. For beam/link failure instances, the WTRU may switch to an alternative beam and/or perform a beam failure recovery procedure to recover an optimal beam and maintain an acceptable packet error rate during reception. During beam failure instances, the WTRU may also recover the optimal beam for continued reception of PDUs before the PDU set level delay expires. In a scenario (e.g., a legacy scenario), the WTRU may be statically configured to count a maximum number of (Cₘₐₓ) beam failure instances before it can indicate to network that beam failure has occurred and initiate the beam failure recovery procedure. Such configuration may enable the WTRU to wait a predetermined duration of time for favorable channel conditions, allowing the beam to recover on its own. The configuration therefore may prevent the WTRU from declaring beam failure too soon and from triggering the beam failure recovery procedure unnecessarily. However, during beam failure occasions while receiving PDUs of a PDU set in delay sensitive applications, such static configuration may not be sufficient for meeting PDU set-level delay requirement.

In an example solution, the WTRU may be configured with multiple maximum count (Cₘₐₓ) values for counting BFIs before sending a BF indication, and may dynamically select the appropriate Cₘₐₓ value to use based on the remaining delay, Dᵣ, for receiving one or more (e.g., all) PDUs of a PDU set after occurrence of a beam failure.

The WTRU may receive additional configuration information related to a beam failure detection duration, T_{BFI}, and an RSRP threshold value for detecting a beam failure instance. In a scenario (e.g., a legacy scenario), the WTRU may be configured to measure RSRP during CSI-RS and/or SRS measurement instances, and the physical (PHY) layer may detect beam failure if the measured RSRP is below the threshold. Upon detecting beam failure, the PHY layer in the WTRU may send an indication to the MAC layer, which in turn may start the BFI count, C₁, and start a BFI timer. The timer in the MAC layer may continue to run until the MAC layer receives a second indication of beam failure from the PHY layer, at which instance the MAC layer may update the BFI count to C₂ and may reset the BFI timer. The MAC layer may continue to increment the BFI count by one, Cₙ₊₁, and reset the timer every time it receives an indication of beam failure from the PHY layer. When the counter reaches the max count, i.e., Cₙ₊₁=Cₘₐₓ, the MAC layer may send an indication to the network requesting to initiate a beam failure recovery procedure. However, if the BFI timer expires (e.g., reaches T_{BFI}) before the WTRU receives the next BFI indication, then the MAC layer may assume that the beam RSRP has recovered, and may reset its BFI count to zero (e.g., C₀).

For dynamic adaptation of the max count (Cₘₐₓ) value, the WTRU may also receive a mapping relation based on associations between the remaining delay, Dᵣ, of a PDU set after the first beam failure instance and the set of max count values (e.g., C_{max_default}, C_{max_1}, C_{max_2}, . . . etc.), which may also include a default, C_{max_default}, max count value, that the WTRU can select. The max count values may also be configured in decreasing order such that C_{max_default}>C_{max_1}>C_{max_2}> . . . etc. In an example, the WTRU may employ a mapping based on the remaining delay, Dᵣ, of a PDU set such that it may use C_{max_1} if Dᵣ<(C_{max_default}−1)*T_{BFI}, or may use C_{max_2} if Dᵣ<(C_{max_1}−1)*T_{BFI}, and so on.

In an example, the WTRU may start receiving PDUs of a PDU set using an optimal beam. At the start of reception of the PDU set, the WTRU may also receive an indication (e.g., in DCI) from the gNB with information on the first PDU of the PDU set. For example, the indication may indicate that a given PDU (e.g., the first PDU) is the start of the PDU set (e.g., the first PDU is the first PDU of the PDU set). The indication regarding the first PDU may be sent at the start of each PDU set as part of downlink control information (DCI).

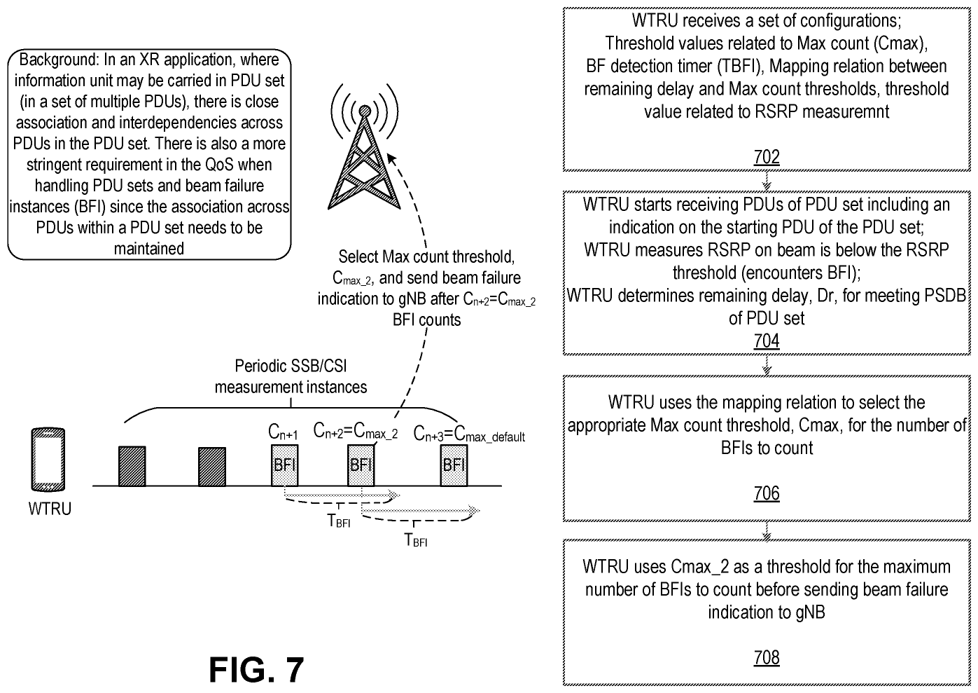

In an example, the WTRU may start receiving PDUs of a PDU set over a beam after getting an indication regarding the first PDU of the PDU set. FIG. 7 illustrates an example of adaptive setting of a maximum count value of BFIs for sending a beam failure recovery request to a gNB. As shown in FIG. 7, the WTRU may also receive CSI-RS and/or SRS periodically for measuring RSRP and determining the beam's received power. If the WTRU measures an RSRP value below the RSRP threshold and/or receives at least one PDU in error, the PHY layer in the WTRU may send, to the MAC layer, the first indication of a beam failure instance, after which the MAC layer may start incrementing the BFI count, C₁, and start the beam failure detection timer, T_{BFI}. Based on the received PDUs, the MAC layer in the WTRU may determine the remaining delay, Dᵣ, for the PDU set after experiencing the first BFI. The WTRU may then employ the mapping relation between the remaining delay, Dᵣ, the set of available max count values, Cₘₐₓ, and the beam failure detection timer for determining the maximum number of BFIs to count before sending a beam failure indication to the network for initiating a beam recovery procedure and maintaining the delay budget. In an example, the MAC layer in the WTRU may be configured to switch back to the default max count value, C_{max_default}, after receiving one or more (e.g., all) PDUs of a PDU set.

In an example, a WTRU may receive a set of configurations including one or more threshold values related to a maximum count (Cₘₐₓ), a BF detection timer (T_{BFI}), one or more mapping relations between remaining delay values and max count thresholds, and/or a threshold value related to RSRP management (e.g., at 702 in FIG. 7). The WTRU may start receiving PDUs of a PDU set (e.g., including an indication of the starting PDU of the PDU set) (e.g., at 704 in FIG. 7). The WTRU may measure an RSRP on a beam, and may determine that the RSRP on the beam is below the RSRP threshold (e.g., the WTRU encounters BFI) (e.g., at 704 in FIG. 7). The WTRU may determine the remaining delay Dᵣ for meeting the PSDB of the PDU set (e.g., at 704 in FIG. 7, and/or as described herein). The WTRU may use the mapping relation(s) to select the appropriate max count threshold, Cₘₐₓ, for the number of BFIs to count (e.g., at 706 in FIG. 7). The WTRU may use C_{max_2} as a threshold for the maximum number of BFIs to count before sending a beam failure indication to the gNB (e.g., at 708 in FIG. 7).

In an example, a WTRU may dynamically adapt the BFR max count threshold, Cₘₐₓ, which may be used to determine when to send an indication of beam failure (BF) to a gNB. The variability may be based on association information (e.g., mapping) between the remaining delay in the PSDB and the configured max count threshold for indicating beam failure. For example, the WTRU may be configured to receive beam failure configuration information including a plurality of thresholds indicating a maximum number of beam failure instances (Bfls) to count before indicating beam failure, a beam failure detection duration, an indication of at least an association between a first threshold of the plurality of thresholds and a minimum delay parameter (e.g., a remaining delay value), and an RSRP threshold for beam failure detection. The WTRU may evaluate for beam failure using the RSRP threshold. The WTRU may receive a first PDU of a PDU set and an indication that the first PDU is a first PDU of a plurality of PDUs in the PDU set. The WTRU may determine that at least one PDU set of the PDU set has not been successfully received (e.g., and/or that the beam failure has occurred). The WTRU may determine that a remaining delay bound of the PDU set is less than or equal to the minimum delay parameter. The WTRU may evaluate for beam failure using the first threshold in response to determining that at least one PDU set of the PDU set has not been successfully received and that the remaining delay bound of the PDU set is less than or equal to the minimum delay parameter. The WTRU may send an indication of beam failure based on determining that a detected number of BFIs exceed the first threshold.

For example, the WTRU may receive, from a network, configuration information indicating a reference signal received power (RSRP) threshold, a beam failure detection duration value, and/or a plurality of associations between respective numbers of consecutive BFIs and remaining delay values. The WTRU may receive a PDU associated with a PDU set over a beam. The WTRU may initialize a counter to a first counter value (e.g., 0). The WTRU may receive an indication that the PDU is the first PDU of the PDU set (e.g., and/or that the PDU is the first PDU of a plurality of PDUs in the PDU set). The WTRU may perform a first RSRP measurement associated with the beam. The WTRU may determine that the first RSRP measurement is less than the received RSRP threshold. The WTRU may increment the counter based on the determination that the first RSRP measurement is less than the received RSRP threshold. The WTRU may determine a remaining delay value associated with the PDU set based on the received PDU. The WTRU may determine a compare value (e.g., (C_{max_1}−1)*T_{BFI}) based on the default value for the number of consecutive BFIs and a beam failure detection duration value. The WTRU may compare the remaining delay value and the compare value. The WTRU may select a value for the number of consecutive BFIs based on the remaining delay value associated with the PDU set and the plurality of associations. For example, the WTRU may select the value for the number of consecutive BFIs if the remaining delay value is less than the compare value. The WTRU may perform a second RSRP measurement and may increment the counter if the WTRU determined that the second RSRP measurement is less than the received RSRP threshold. The WTRU may transmit an indication of a beam failure based on the selected value for the number of consecutive BFIs. For example, the WTRU may transmit the indication of beam failure based on the number of consecutive BFIs reaching (e.g., being greater than or equal to) the selected value.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. A method implemented in a wireless transmit/receive unit (WTRU), the method comprising:
receiving, from a network, configuration information comprising a reference signal received power (RSRP) threshold and a plurality of associations between respective numbers of consecutive beam failure instances (BFIs) and remaining delay values;
receiving, over a beam, a packet data unit (PDU) associated with a PDU set;
performing a first RSRP measurement associated with the beam;
determining that the first RSRP measurement is less than the received RSRP threshold;
determining a remaining delay value associated with the PDU set based on the received PDU;
selecting a value for the number of consecutive BFIs based on the remaining delay value associated with the PDU set and the plurality of associations; and
transmitting, to the network, an indication of a beam failure based on the selected value for the number of consecutive BFIs.

2. The method of claim 1, further comprising receiving an indication that the PDU is a first PDU of a plurality of PDUs in the PDU set.

3. The method of claim 1, further comprising:
incrementing a counter based on the determination that the first RSRP measurement is less than the received RSRP threshold;
determining a compare value based on a default value for the number of consecutive BFIs and a beam failure detection duration value;
comparing the remaining delay value associated with the PDU set with the compare value; and
on a condition that the remaining delay value is less than the compare value, selecting the value for the number of consecutive BFIs based on the remaining delay value and the configuration information.

4. The method of claim 3, wherein the configuration information further comprises the beam failure detection duration value.

5. The method of claim 3, further comprising:
determining that a timer has not expired; and
incrementing the counter based on the determination that the first RSRP measurement is less than the received RSRP threshold and the determination that the timer has not expired.

6. The method of claim 1, further comprising:
initializing a counter to a first counter value; and
upon determining that the first RSRP measurement is less than the received RSRP threshold, incrementing the counter to a second counter value.

7. The method of claim 6, further comprising:
performing a second RSRP measurement;
determining that the second RSRP measurement is less than the received RSRP threshold; and
upon determining that the second RSRP measurement is less than the received RSRP threshold, incrementing the counter to a third counter value.

8. The method of claim 6, wherein transmitting the indication of the beam failure based on the selected value for the number of consecutive BFIs comprises:
determining that the second counter value is equal to or greater than the value for the number of consecutive BFIs; and
transmitting the indication of the beam failure based on the determination that the second counter value is equal to or greater than the value for the number of consecutive BFIs.

9. A wireless transmit/receive unit (WTRU) comprising:
a processor configured to:
receive, from a network, configuration information comprising a reference signal received power (RSRP) threshold and a plurality of associations between respective numbers of consecutive beam failure instances (BFIs) and remaining delay values;
receive, over a beam, a packet data unit (PDU) associated with a PDU set;
perform a first RSRP measurement associated with the beam;
determine that the first RSRP measurement is less than the received RSRP threshold;
determine a remaining delay value associated with the PDU set based on the received PDU;
select a value for the number of consecutive BFIs based on the remaining delay value associated with the PDU set and the plurality of associations; and
transmit, to the network, an indication of a beam failure based on the selected value for the number of consecutive BFIs.

10. The WTRU of claim 9, wherein the processor is further configured to receive an indication that the PDU is a first PDU of a plurality of PDUs in the PDU set.

11. The WTRU of claim 9, wherein the processor is further configured to:
increment a counter based on the determination that the first RSRP measurement is less than the received RSRP threshold;
determine a compare value based on a default value for the number of consecutive BFIs and a beam failure detection duration value;
compare the remaining delay value associated with the PDU set with the compare value; and
on a condition that the remaining delay value is less than the compare value, select the value for the number of consecutive BFIs based on the remaining delay value and the configuration information.

12. The WTRU of claim 11, wherein the configuration information further comprises the beam failure detection duration value.

13. The WTRU of claim 11, wherein the processor is further configured to:
determine that a timer has not expired; and
increment the counter based on the determination that the first RSRP measurement is less than the received RSRP threshold and the determination that the timer has not expired.

14. The WTRU of claim 9, wherein the processor is further configured to:
initialize a counter to a first counter value; and
upon determining that the first RSRP measurement is less than the received RSRP threshold, increment the counter to a second counter value

15. The WTRU of claim 14, wherein the processor is further configured to:
perform a second RSRP measurement;
determine that the second RSRP measurement is less than the received RSRP threshold; and
upon determining that the second RSRP measurement is less than the received RSRP threshold, increment the counter to a third counter value.

16. The WTRU of claim 14, wherein the processor being configured to transmit the indication of the beam failure based on the selected value for the number of consecutive BFIs comprises the processor being configured to:
determine that the second counter value is equal to or greater than the value for the number of consecutive BFIs; and
transmit the indication of the beam failure based on the determination that the second counter value is equal to or greater than the value for the number of consecutive BFIs.
